(19) United States
(12) Patent Application Publication
(10) Pub. No.: US 2011/0126144 A1
(43) Pub. Date: May 26, 2011

(54) EQUIPMENT MANAGEMENT APPARATUS

(75) Inventors: Yoshihiko Sakaguchi, Shiga (JP); Toshiyuki Miki, Shiga (JP); Masahiro Kaneko, Shiga (JP)

(73) Assignee: DAIKIN INDUSTRIES, LTD., Osaka-shi, Osaka (JP)

(21) Appl. No.: 12/992,915

(22) PCT Filed: May 19, 2009
(86) PCT No.: PCT/JP2009/002192

§ 371 Date: Nov. 16, 2010

(30) Foreign Application Priority Data
May 22, 2008 (JP) 2008-134665
May 29, 2008 (JP) 2008-141509
Oct. 7, 2008 (JP) 2008-260363

(51) Int. Cl. G06F 3/048

(52) U.S. Cl. 715/771

(57) ABSTRACT

An equipment management apparatus is configured to provide a management screen in order to manage a plurality of equipments scattered within a superordinate space including a plurality of subordinate spaces. The equipment management apparatus includes a first display control section and a condition determination section. The first display control section displays a superordinate object and a plurality of subordinate objects in a tree structure on the management screen. The superordinate object corresponds to the superordinate space, and the subordinate objects correspond to the subordinate spaces. The condition determination section determines whether or not the equipments satisfy a predetermined condition. The first display control section changes a visual aspect of at least one of the subordinate objects depending on a result of the determination by the condition determination section regarding whether or not one or more equipments disposed in the subordinate space corresponding to the subordinate object satisfy the predetermined condition.

### TECHNICAL FIELD

The present invention relates to an equipment management apparatus configured to provide a management screen for managing a plurality of equipments.

### BACKGROUND ART

A plurality of equipments (including e.g., a plurality of indoor units in a single air-conditioning installation) has been centrally controlled through a single management screen within a single facility (PTL 1: Japan Laid-open Patent Application Publication No. JP-A-2005-308278). The facility herein refers to one of the group of various sized facilities including private households, office buildings, colleges/universities composed of a plurality of building complexes, hospitals, and the like.

### SUMMARY OF THE INVENTION

### Technical Problem

However, manageable contents through a single management screen will be limited in proportion to increase in facility size and increase in the number of equipments as management targets. For example, this may result in such a problem that an administrator, operating a management screen, is not informed promptly and accurately of troubles and the like occurred in equipments. It is preferable to appropriately design the management screen for avoiding the above problem.

It is an object of the present invention to provide an equipment management apparatus configured to provide a management screen for rationally managing a plurality of equipments.

### Solution to Problem

An equipment management apparatus according to a first aspect of the present invention is configured to provide a management screen for managing a plurality of equipments scattered within a superordinate space including a plurality of subordinate spaces. The equipment management apparatus includes a first display control section and a condition determination section. The first display control section is configured to display a superordinate object and a plurality of subordinate objects in a tree structure on the management screen. The superordinate object corresponds to the superordinate space, whereas the subordinate objects respectively correspond to the subordinate spaces. The condition determination section is configured to determine whether or not the equipments satisfy a predetermined condition. Further, the first display control section is configured to change a visual aspect of each of the subordinate objects depending on a result of the determination by the condition determination section regarding whether or not one or more equipments disposed in the subordinate space corresponding to the subordinate object satisfy the predetermined condition. It should be noted that the tree structure may reflect the actual physical space structure or the logical space structure.

According to the equipment management apparatus of the first aspect of the present invention, a space including a plurality of equipments installed therein (i.e., the superordinate space) is expressed in a tree structure. The tree structure herein includes an object corresponding to the space and objects corresponding to a plurality of sub-spaces thereof (i.e., the subordinate spaces) as components thereof. Further, the visual aspects of the objects corresponding to the subordinate spaces (i.e., the subordinate objects) are configured to be changed depending on the states of the equipments disposed in the subordinate spaces. When watching the management screen, an administrator is allowed to intuitively understand the states of the equipments based on the visual aspects of the subordinate objects. Accordingly, it is possible to rationally manage a plurality of equipments.

It should be noted that the equipment management apparatus may provide the management screen by displaying the management screen on the display unit of the equipment management apparatus, or it may provide the management screen by displaying the management screen on a display unit of another apparatus connect to the equipment management apparatus.

An equipment management apparatus according to a second aspect of the present invention relates to the equipment management apparatus according to the first aspect of the present invention. The equipment management apparatus further includes a second display control section. The second display control section is configured to display on the management screen the tree structure and a schematic view of the superordinate space or the subordinate space corresponding to one of the superordinate object and the subordinate objects currently selected in the tree structure.

According to the equipment management apparatus of the second aspect of the present invention, the tree structure and the schematic view of the space currently selected in the tree structure (i.e., the superordinate space or any one of the subordinate spaces) are displayed. Therefore, an administrator is allowed to easily select his/her desired space through the tree structure and intuitively understand the state of the space currently selected through the schematic view.

An equipment management apparatus according to a third aspect of the present invention relates to the equipment management apparatus according to the second aspect of the present invention. In the equipment management apparatus, the schematic view includes a floor plan of the superordinate space or subordinate space and one or more equipment objects respectively corresponding to one or more equipments.

According to the equipment management apparatus of the third aspect of the present invention, the tree structure and the floor plan of a space currently selected in the tree structure (i.e., the superordinate space or any one of the subordinate spaces) are displayed. Further, one or more objects respectively corresponding to one or more equipments (i.e., equipment objects) are disposed on the floor plan. Therefore, an administrator is allowed to easily select his/her desired space through the tree structure and intuitively understand the states of the equipments disposed in the space currently selected through a schematic view.

An equipment management apparatus according to a fourth aspect of the present invention relates to the equipment management apparatus according to the third aspect of the present invention. In the equipment management apparatus, the equipment objects function as links to detailed information about the equipments corresponding to the equipment objects.

According to the equipment management apparatus of the fourth aspect of the present invention, the detailed information about the equipment corresponding to the object (equipment object) is configured to be brought to an administrator when he/she selects the object on the floor plan of the space. Therefore, an administrator is allowed to grasp the states of the equipments in detail.

An equipment management apparatus according to a fifth aspect of the present invention relates to the equipment management apparatus according to one of the first to fourth aspects of the present invention. In the equipment management apparatus, the first display control unit is configured to change the visual aspect of each of the subordinate objects depending on a result of the determination by the condition determination section regarding whether or not at least one of the equipments disposed in the subordinate space corresponding to the subordinate object satisfies the predetermined condition.

According to the equipment management apparatus of the fifth aspect of the present invention, the visual aspects of the subordinate objects are configured to be changed depending on a result of the determination regarding whether or not at least one of the equipments disposed in the subordinate spaces satisfies the predetermined condition. Therefore, an administrator is allowed to further rationally grasp the states of the plural equipments disposed in single subordinate space by watching the visual aspect of the single subordinate object.

An equipment management apparatus according to a sixth aspect of the present invention relates to the equipment management apparatus according to one of the first to fifth aspects of the present invention. In the equipment management apparatus, the first display control section is configured to change a visual aspect of the superordinate object depending on a result of the determination by the condition determination section regarding whether or not the equipments disposed in the superordinate space corresponding to the superordinate object satisfy the predetermined condition.

According to the equipment management apparatus of the sixth aspect of the present invention, the visual aspect of the object corresponding to the superordinate space (i.e., the superordinate object) is changed depending on the states of the equipments within the superordinate space. Therefore, an administrator is allowed to intuitively understand the states of the equipments by watching the visual aspect of the superordinate object.

An equipment management apparatus according to a seventh aspect of the present invention relates to the equipment management apparatus according to the sixth aspect of the present invention. In the equipment management apparatus, the first display control section is configured to change the visual aspect of the superordinate object depending on a result of determination by the condition determination section regarding whether or not at least one of the equipments disposed in the superordinate space corresponding to the superordinate object satisfies the predetermined condition.

According to the equipment management apparatus of the seventh aspect of the present invention, the visual aspect of the superordinate object is changed depending on a result of the determination regarding whether or not at least one of the plural equipments disposed in the superordinate space satisfies the predetermined condition. Therefore, an administrator is allowed to further rationally grasp the states of the plural equipments disposed in the superordinate space by watching the visual aspect of the single superordinate object.

An equipment management apparatus according to an eighth aspect of the present invention relates to the equipment management apparatus according to one of the first to seventh aspects of the present invention. In the equipment management apparatus, the predetermined condition includes an exclusion condition and an extraction condition. Further, the condition determination section is configured to determine that a given one of the equipments satisfies the predetermined condition when the given one of the equipments satisfies the extraction condition but dissatisfies the exclusion condition.

According to the equipment management apparatus of the eighth aspect of the present invention, an equipment/equipments, satisfying a condition (i.e., the exclusion condition), is/are firstly excluded. Next, it is confirmed whether or not the rest of the equipments satisfy another condition (i.e., the extraction condition). A result of confirmation is reflected in the tree structure (more accurately, the visual aspects of the subordinate objects). Therefore, the states of the equipments can be further rationally confirmed.

An equipment management apparatus according to a ninth aspect of the present invention relates to the equipment management apparatus according to the eighth aspect of the present invention. The equipment management apparatus further includes a configuration input unit. The configuration input unit is configured to receive a configuration input of the exclusion condition.

According to the equipment management apparatus of the ninth aspect of the present invention, an administrator is allowed to set the exclusion condition. Therefore, the administrator is allowed to appropriately confirm the states of the equipments.

An equipment management apparatus according to a tenth aspect of the present invention relates to the equipment management apparatus according to one of the first to ninth aspects of the present invention. The equipment management apparatus further includes a logic storage unit and a logic execution section. The logic storage unit is configured to store a control logic. The logic execution section is configured to execute the control logic triggered by signals outputted by the condition determination section depending on a result of the determination regarding whether or not the equipments satisfy the predetermined condition.

According to the equipment management apparatus of the tenth aspect of the present invention, the control logic is configured to be executed (i.e., triggered) when the predetermined condition is satisfied for determining the visual aspects of the subordinate objects. Accordingly, it is possible to execute control linked to the visual aspects of the subordinate objects.

An equipment management apparatus according to an eleventh aspect of the present invention relates to the equipment management apparatus according to one of the first to tenth aspects of the present invention. The equipment management apparatus further includes a name storage section. The name storage section is configured to store respective equipment names of the equipments. Further, the first display control section is configured to automatically create the tree structure with reference to the equipment names stored in the name storage section.

According to the equipment management apparatus of the eleventh aspect of the present invention, the tree structure can be automatically created, for instance, only by naming the equipment in accordance with a predetermined rule.

An equipment management apparatus according to a twelfth aspect of the present invention relates to the equipment management apparatus according to one of the first to seventh aspects of the present invention. In the equipment management apparatus, the predetermined condition includes a plurality of condition formulas having a priority order preliminarily defined. Further, when the condition determination section determines that one or more equipments disposed in the subordinate space corresponding to the subordinate object satisfy two or more of the condition formulas, the first display control section is configured to display the visual aspect of each of the subordinate objects in a display format corresponding to a highest-prioritized one of the aforementioned two or more of the condition formulas.

According to the equipment management apparatus of the twelfth aspect of the present invention, the states of the equipments are determined based on the condition formulas for determining the visual aspects of the subordinate objects. When the equipments satisfy one or more of the condition formulas, the visual aspects of the subordinate objects are determined and displayed in a display format corresponding to a highest-prioritized one of the satisfied condition formulas. Accordingly, an administrator is allowed to judge highly complex states of the equipments by watching the visual aspects of the subordinate objects.

An equipment management apparatus according to a thirteenth aspect of the present invention relates to the equipment management apparatus according to one of the sixth and seventh aspects of the present invention. In the equipment management apparatus, the predetermined condition includes a plurality of condition formulas having a priority order preliminarily defined. Further, when the condition determination section determines that the equipments disposed in the superordinate space corresponding to the superordinate object satisfies two or more of the condition formulas, the first display control section is configured to display the visual aspect of the superordinate object in a display format corresponding to a highest-prioritized one of the aforementioned two or more of the condition formulas.

According to the equipment management apparatus of the thirteenth aspect of the present invention, the states of the equipments are determined based on the condition formulas for determining the visual aspect of the superordinate object. When the states of the equipments satisfy one or more of the condition formulas, the visual aspect of the superordinate object is determined and displayed in a display format corresponding to a highly-prioritized one of the satisfied condition formulas. Accordingly, an administrator is allowed to judge highly complex states of the equipments by watching the visual aspect of the superordinate object.

An equipment management apparatus according to a fourteenth aspect of the present invention relates to the equipment management apparatus according to one of the twelfth and thirteenth aspects of the present invention. The equipment management apparatus further includes a configuration input unit. The configuration input unit is configured to receive a configuration input of the priority order.

According to the equipment management apparatus of the fourteenth aspect of the present invention, an administrator is allowed to define the priority order among a plurality of the condition formulas for determining the visual aspects of the objects.

An equipment management apparatus according to a fifteenth aspect of the present invention relates to the equipment management apparatus according to one of the first to fourteenth aspects of the present invention. The equipment management apparatus further includes a request source specifying unit and a condition formula storage unit. The request source specifying unit is configured to specify a request source requesting the management screen. The condition formula storage unit is configured to store the predetermined condition in association with the request source. Further, the first display control section is configured to change the visual aspect of each of the subordinate objects on the management screen to be provided to the request source specified by the request source specifying unit depending on a result of the determination by the condition determination section regarding whether or not one or more equipments disposed in the subordinate space corresponding to the subordinate object satisfy the predetermined condition associated with the request source.

According to the equipment management apparatus of the fifteenth aspect of the present invention, the predetermined condition can be defined for each of the respective request sources accessing the equipment management apparatus. It is thereby possible to provide different request sources with the management screen in different display formats.

### ADVANTAGEOUS EFFECTS OF INVENTION

According to the equipment management apparatus of the first aspect of the present invention, an administrator, watching the management screen, is allowed to intuitively understand the states of the equipments based on the visual aspects of the subordinate objects. Therefore, it is possible to rationally manage a plurality of equipments.

According to the equipment management apparatus of the second aspect of the present invention, an administrator is allowed to easily select his/her desired space through the tree structure and intuitively understand the state of the space currently selected through the schematic view.

According to the equipment management apparatus of the third aspect of the present invention, an administrator is allowed to easily select his/her desired space through the tree structure and intuitively understand the states of the equipments disposed in the space currently selected through a schematic view.

According to the equipment management apparatus of the fourth aspect of the present invention, an administrator is allowed to grasp the states of the equipments in detail.

According to the equipment management apparatus of the fifth aspect of the present invention, an administrator is allowed to further rationally grasp the states of a plurality of equipments disposed in single subordinate space by watching the visual aspect of a single subordinate object.

According to the equipment management apparatus of the sixth aspect of the present invention, an administrator is allowed to intuitively understand the states of the equipments by watching the visual aspect of the superordinate object.

According to the equipment management apparatus of the seventh aspect of the present invention, an administrator is allowed to further rationally grasp the states of the plural equipments disposed in the superordinate space by watching the visual aspect of the single superordinate object.

According to the equipment management apparatus of the eighth aspect of the present invention, the states of the equipments can be further rationally confirmed.

According to the equipment management apparatus of the ninth aspect of the present invention, an administrator is allowed to appropriately confirm the states of the equipments.

According to the equipment management apparatus of the tenth aspect of the present invention, it is possible to execute control linked to the visual aspects of the subordinate objects.

According to the equipment management apparatus of the eleventh aspect of the present invention, the tree structure can be automatically created, for instance, only by naming the equipment in accordance with a predetermined rule.

According to the equipment management apparatus of the twelfth aspect of the present invention, an administrator is allowed to judge highly complex states of the equipments by watching the visual aspects of the subordinate objects.

According to the equipment management apparatus of the thirteenth aspect of the present invention, an administrator is allowed to judge highly complex states of the equipments by watching the visual aspect of the superordinate object.

According to the equipment management apparatus of the fourteenth aspect of the present invention, an administrator is allowed to define the priority order among a plurality of the condition formulas for determining the visual aspects of the objects.

According to the equipment management apparatus of the fifteenth aspect of the present invention, it is possible to provide different request sources with the management screen in different display formats.

### BRIEF DESCRIPTION OF THE DRAWINGS

FIG. 1 is a configuration diagram of a group management system including a parent controller according to an exemplary embodiment of the present invention.

FIG. 2 is a configuration diagram of respective indoor units.

FIG. 3 is a configuration diagram of a child controller.

FIG. 4 is a configuration diagram of the parent controller.

FIG. 5 is a data structural diagram of a floor-plan database.

FIG. 6 is a data structural diagram of a fundamental information database.

FIG. 7 is a data structural diagram of an operation information database.

FIG. 8 is a data structural diagram of a trouble history database.

FIG. 9 is a diagram of a management screen to be displayed while an object corresponding to an entire facility is currently selected.

FIG. 10 is a diagram of a management screen to be displayed while an object corresponding to a given building is currently selected.

FIG. 11 is a diagram of a management screen to be displayed while an object corresponding to a given unit space is currently selected.

FIG. 12 is a diagram of a management screen according to a modification (9).

FIG. 13 is a diagram of a management screen according to a modification (10).

FIG. 14 is a diagram of a management screen according to a modification (11).

FIG. 15 is a diagram of a display configuration screen.

### DESCRIPTION OF EMBODIMENTS

A group management system 100, including a parent controller 30 (an equipment management apparatus) according to an exemplary embodiment of the present invention, will be hereinafter explained with reference to the figures.

### First Exemplary Embodiment

(1) Entire Structure

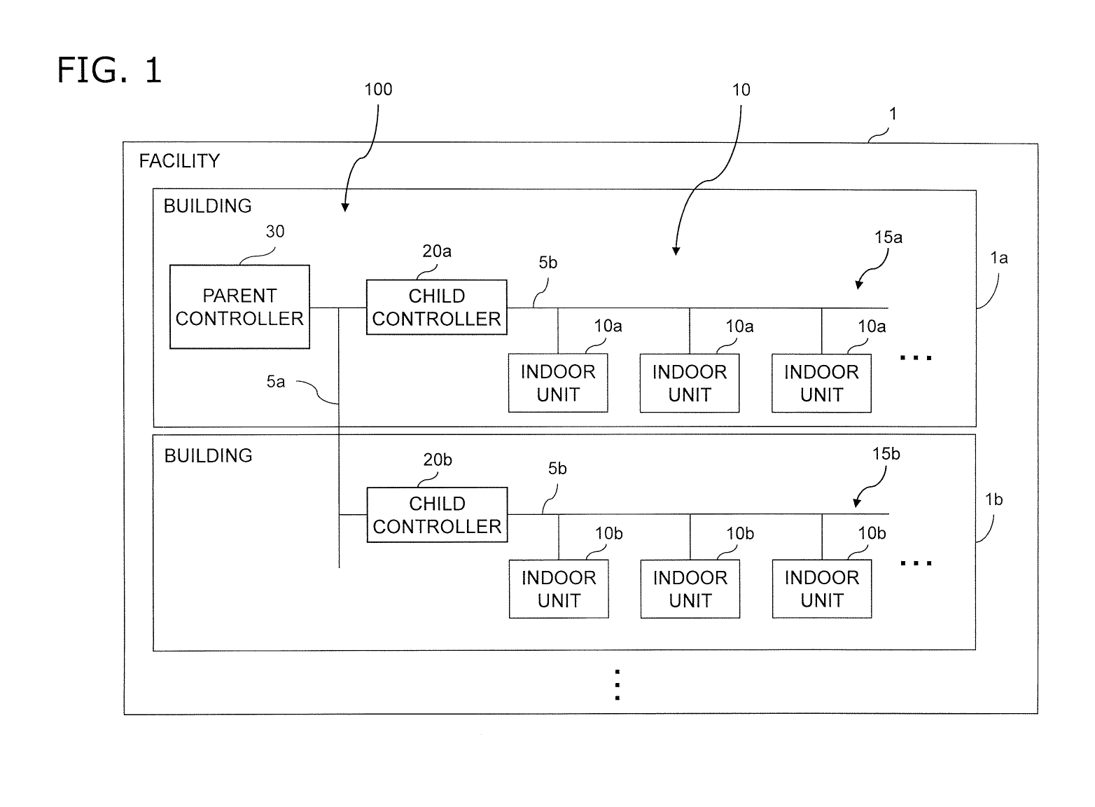

The group management system 100, illustrated in FIG. 1, is a system for managing an air-conditioning installation 10 (i.e., equipments) installed in a facility 1. The facility 1 is a college/university including a plurality of buildings 1a, 1b, and the like within its vast area. Each building 1a, 1b or the like includes a plurality of indoor units 10a, 10b or the like included in the air-conditioning installation 10. The plural indoor units 10a, 10b or the like installed in a single building 1a, 1b or the like form an indoor unit group 15a, 15b or the like while being virtually organized by the group management system 100 for a management purpose.

The group management system 100 includes the parent controller 30 and a plurality of child controllers 20a, 20b and the like. Each of the child controllers 20a, 20b and the like is configured to manage each of the plural indoor unit groups 15a, 15b and the like, whereas the parent controller 30 is configured to organize the plural child controllers 20a, 20b and the like. Each of the child controllers 20a, 20b and the like is installed in a control room of each of the buildings 1a, 1b and the like. Each child controller 20a, 20b or the like is correspondingly connected to the plural indoor units 10a, 10b or the like within the same building 1a, 1b or the like through a private control line 5b exclusively used for the air-conditioning installation 10. The parent controller 30, together with the child controller 20a, is installed in the control room of the building 1a. The parent controller 30 is connected to the child controllers 20a, 20b and the like through a local area network (hereinafter referred to as LAN) 5a. It should be noted that network apparatuses (not illustrated in the figure) not directly related to management of the air-conditioning installation 10 are herein connected to the LAN 5a, excluding the parent controller 30 and the child controllers 20a, 20b and the like. For example, the network apparatuses herein include personal computers and printers used by users within the facility 1 for executing routine work.

(2) Indoor Unit Configuration

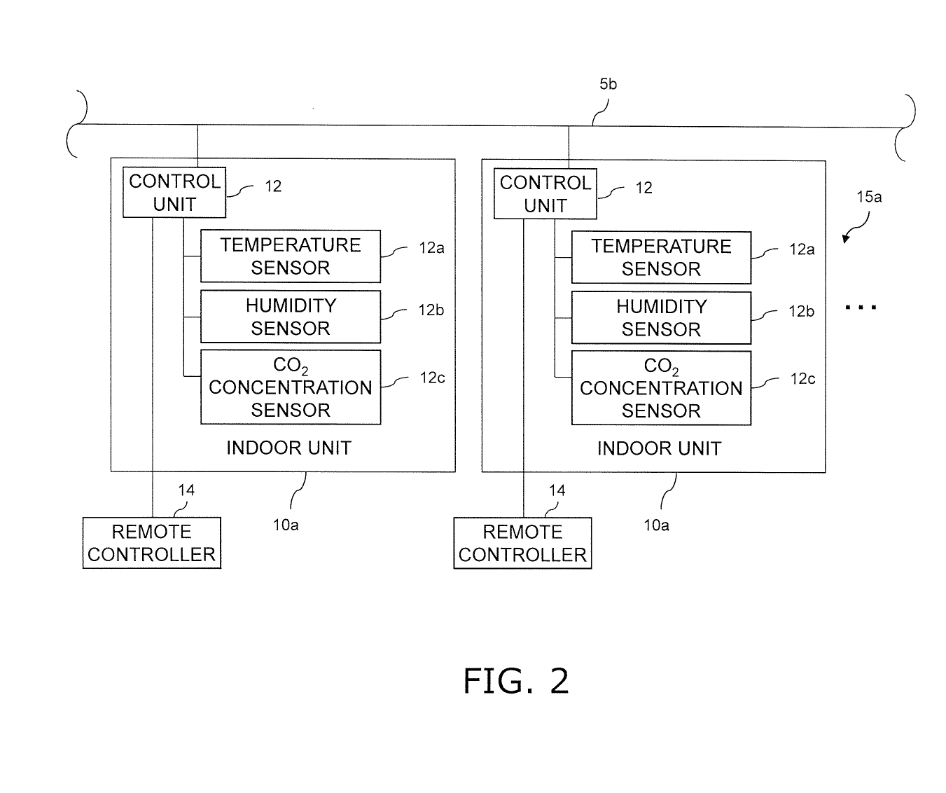

The indoor units 10a will be hereinafter explained with reference to FIG. 2. However, the remaining indoor units 10b and the like are assumed to have configurations identical to the configuration of the indoor units 10a.

Each indoor unit 10a includes a control unit 12. The control units 12 of the indoor units 10a, belonging to the same refrigerant circuit, are connected through the private control line 5b exclusively used for the air-conditioning installation 10. Further, each control unit 12 is connected to components belonging to the same refrigerant circuit (i.e., a corresponding outdoor unit (not illustrated in the figure) and the child controller 20a) through the private control line 5b exclusively used for the air-conditioning installation 10.

To cool or heat an indoor room, each control unit 12 is configured to control actions of various components within the same refrigerant circuit in response to an operation command inputted by a user through a remote controller 14, the child controller 20a or the parent controller 30, while cooperating with a control unit (not illustrated in the figure) of a corresponding outdoor unit belonging to the same refrigerant circuit. For example, the operation command herein includes a command of activating/deactivating each indoor unit 10a, a command of changing a temperature setting of each indoor unit 10a, and a command of changing an operation mode of each indoor unit 10a). Specifically, each control unit 12 is configured to regulate frequency of a compressor, revolution of a fan, opening degrees of various valves, and the like. It should be noted that each remote controller 14 is mainly configured to receive an operation command for each indoor unit 10a from a general user. Further, remote controllers 14 are directly connected to the control units 12 of indoor units 10a on a one-to-one basis or on a one-to-many basis without intervention of the other controllers 20a, 30 and the like.

Each control unit 12 is connected to each of sensors including a temperature sensor 12a, a humidity sensor 12b and a CO₂ concentration sensor 12c. The temperature sensor 12a, the humidity sensor 12b, and the CO₂ concentration sensor 12c are attached to the vicinity of an air inlet of each indoor unit 10a for respectively detecting temperature, humidity, and CO₂ concentration in the surrounding of each indoor unit 10a.

Further, each control unit 12 is configured to transmit information related to an operation state of each indoor unit 10a (hereinafter referred to as operation information of each indoor unit 10a) to the child controller 20a in response to a command from the child controller 20a. The operation information of each indoor unit 10a herein includes information indicating: temperature, humidity and CO₂ concentration in the surrounding of the indoor unit 10a; an activation state (e.g., activation or deactivation); a temperature setting; and an operation mode (e.g., a cooling mode, a heating mode, and a ventilation mode).

(3) Child controller Configuration

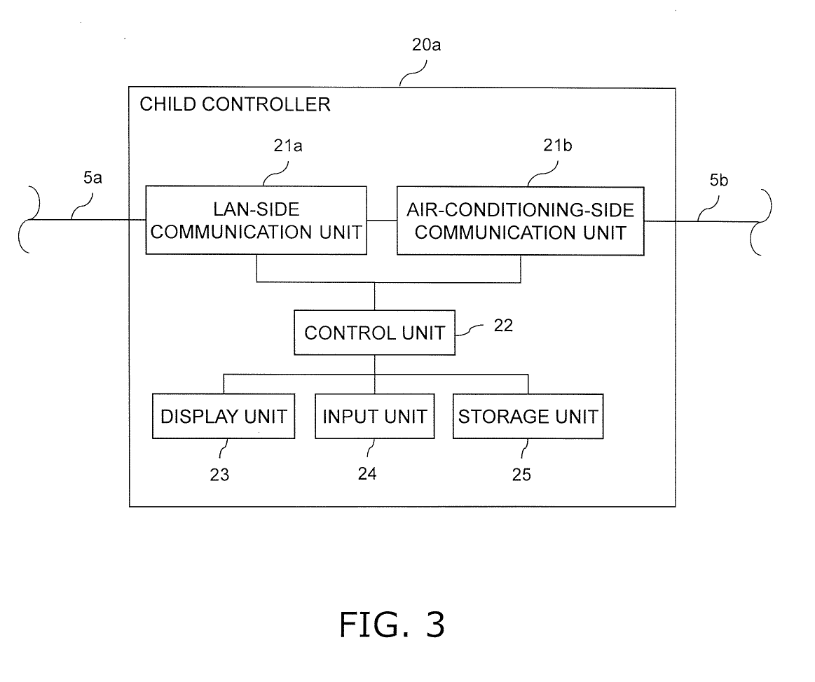

The child controller 20a will be hereinafter explained with reference to FIG. 3. However, the remaining child controllers 20b and the like are configured to have configurations identical to the configuration of the child controller 20a.

The child controller 20a is installed in the control room of the building 1a. The child controller 20a is manipulated by an administrator belonging to the control room. The child controller 20a mainly includes a LAN-side communication unit 21a, an air-conditioning-side communication unit 21b, a control unit 22, a display unit 23, an input unit 24 and a storage unit 25. The child controller 20a is configured to monitor and control the indoor units 10a included in the indoor unit group 15a.

The LAN-side communication unit 21a is a network interface for connecting the child controller 20a to the LAN 5a. The LAN-side communication unit 21a is configured to transmit/receive various signals to/from the parent controller 30. On the other hand, the air-conditioning-side communication unit 21b is a network interface for connecting the child controller 20a to the private control line 5b. The air-conditioning-side communication unit 21b is configured to transmit/receive various signals to/from the indoor unit 10a.

The control unit 22 mainly includes a CPU, a ROM, and a RAM. The control unit 22 is configured to read out and run a program stored in the storage unit 25. For example, the control unit 22 is configured to obtain the operation information of a given indoor unit 10a included in the indoor unit group 15a from the control unit 12 of the indoor unit 10a at predetermined time intervals (every one minute in the present exemplary embodiment). The control unit 22 is subsequently configured to transmit the obtained operation information to the parent controller 30. Further, the control unit 22 is configured to obtain not only the operation information of each indoor unit 10a but also information related to an operation state of each outdoor unit (hereinafter referred to as operation information of each outdoor unit) at predetermined time intervals (every one minute in the present exemplary embodiment). The operation information of each outdoor unit herein includes information indicating: frequency of a compressor; and temperature and pressure of a refrigerant.

Further, the control unit 22 is configured to determine whether or not a trouble occurs in each indoor unit 10a and/or each outdoor unit based on the operation information of each indoor unit 10a and the operation information of each outdoor unit at a predetermined clock time stored within the storage unit 25 at predetermined time intervals (every one minute in the present exemplary embodiment). When determining that a trouble occurs in each indoor unit 10a and/or each outdoor unit, the control unit 22 causes the display unit 23 to display a content indicating occurrence of the trouble and informs the parent controller 30 of the content.

Yet further, when receiving an operation command regarding a given indoor unit 10a from the parent controller 30 through the LAN-side communication unit 21a, the control unit 22 is configured to transmit the operation command to the indoor unit 10a through the air-conditioning-side communication unit 21b.

The display unit 23 mainly includes a display, whereas the input unit 24 mainly includes a touch panel covering the display and manipulation keys.

The storage unit 25 reliably contains an operation information storage area. The operation information obtained by the control unit 22 (i.e., the operation information of each indoor unit 10a and the operation information of each outdoor unit) are accumulated in the operation information storage area for a predetermined period of time.

(4) Configuration of Parent controller 30

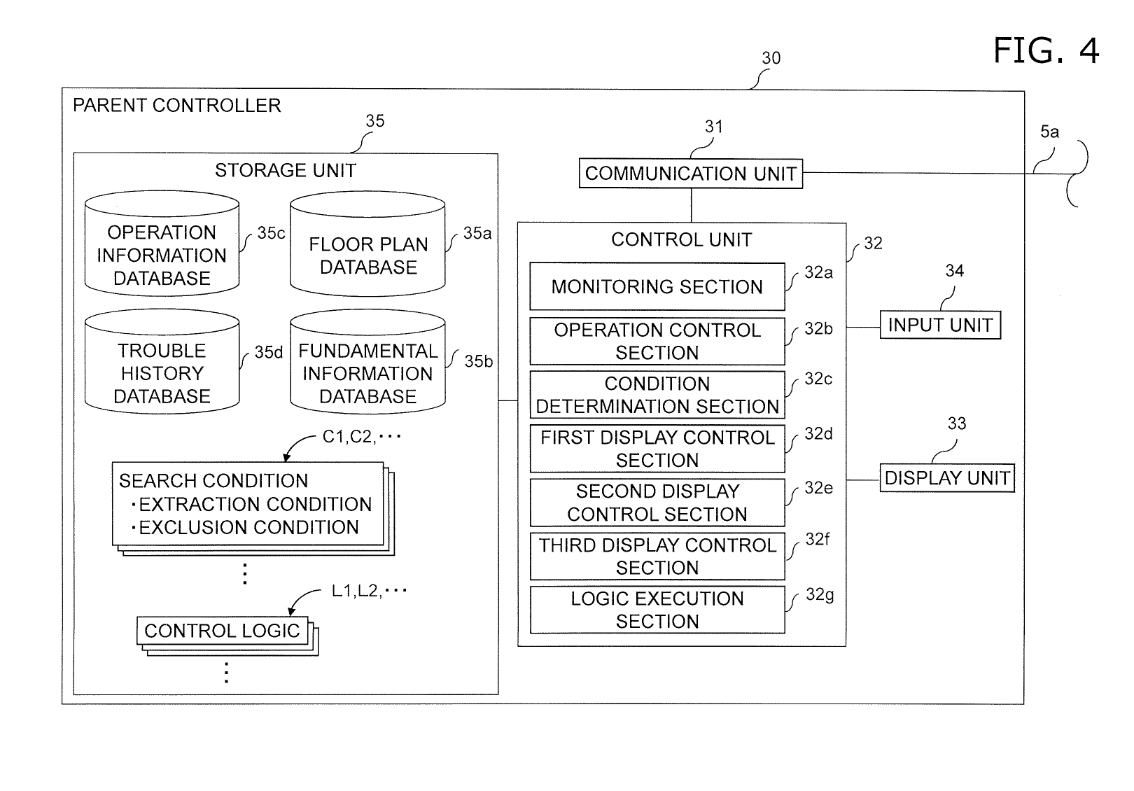

The parent controller 30 is a normal personal computer. As illustrated in FIG. 4, the parent controller 30 mainly includes a communication unit 31, a control unit 32, a display unit 33, an input unit 34 and a storage unit 35. The parent controller 30 is installed in the control room (existing in the building 1a) for managing the entire air-conditioning installation 10 within the facility 1. The parent controller 30 is manipulated by a supervisory administrator belonging to the control room.

The communication unit 31 is a network interface for connecting the parent controller 30 to the LAN 5a. The communication unit 31 is configured to transmit/receive various signals to/from the child controllers 20a, 20b and the like.

The control unit 32 mainly includes a CPU, a ROM and a RAM. The control unit 32 is configured to read out and run a program stored in the storage unit 35 for acting as a monitoring section 32a, an operation control section 32b, a condition determination section 32c, a first display control section 32d, a second display control section 32e, a third display control section 32f and a logic execution section 32g.

The monitoring section 32a is configured to collect the respective operation information of the indoor units 10a, 10b and the like through the child controllers 20a, 20b and the like. The operation control section 32b is configured to transmit operation commands to the respective control units 12 of the indoor units 10a, 10b and the like through the child controllers 20a, 20b and the like for controlling operations of the indoor units 10a, 10b and the like. Further, the operation control section 32b is configured to receive registrations of the operation schedules for the indoor units 10a, 10b and the like through the input unit 34. Based on the operation schedules, the operation control section 32b is configured to transmit an appropriate operation command to a corresponding one of the indoor units 10a, 10b and the like at an appropriate timing. The condition determination section 32c is configured to search a single or plurality of indoor units satisfying search conditions C1, C2 and the like (described below) stored in the storage unit 35 from the indoor units 10a, 10b and the like. In cooperation with the condition determination section 32c, the first display control section 32d, the second display control section 32e and the third display control section 32f are configured to create a management screen to be displayed on the display unit 33 for managing the indoor units 10a, 10b and the like. The logic execution section 32g is configured to execute control logics L1, L2 and the like stored in the storage unit 35. Actions of the respective units 32a to 32g will be hereinafter described in detail.

The display unit 33 mainly includes a display, whereas the input unit 34 mainly includes a mouse and a keyboard.

The storage unit 35 mainly includes a hard disc drive. The storage unit 35 contains a floor plan database 35a, a fundamental information database 35b, an operation information database 35c and a trouble history database 35d. The floor plan database 35a stores the floor plan of the entre facility 1 and the floor plans of the spaces forming the facility 1. The fundamental information database 35b stores the fundamental information of the indoor units 10a, 10b and the like. The operation information database 35c accumulates the operation information of the indoor units 10a, 10b and the like. The trouble history database 35d stores the information regarding troubles (hereinafter referred to as trouble information) of the indoor units 10a, 10b and the like and the outdoor units. Excluding the above, the storage unit 35 further stores information to be inputted through the input unit 34 regarding the operation schedules of the indoor units 10a, 10b and the like.

a) Floor Plan Database

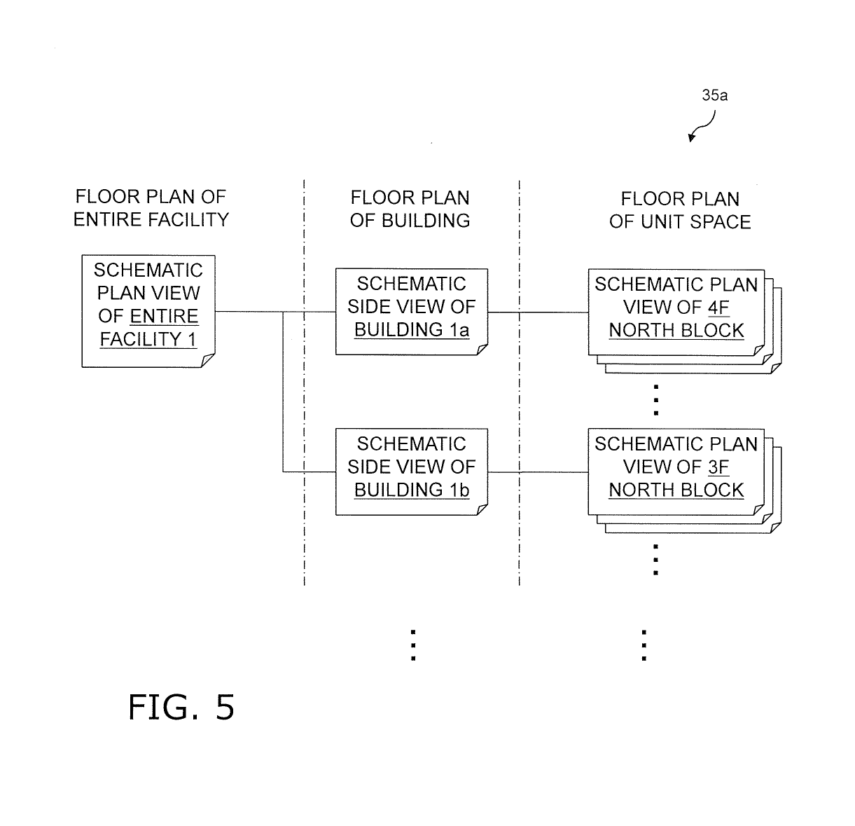

As illustrated in FIG. 5, the floor plan database 35a is a hierarchical database. More specifically, the floor plan database 35a hierarchically stores a schematic plan view of the entire facility 1, schematic side views of the buildings 1a, 1b and the like forming the facility 1, and schematic plan views of unit spaces forming the respective buildings 1a, 1b and the like. The hierarchical structure corresponds to the physical space structure of the facility 1 in the real world. Simply put, the schematic plan view of the entire facility 1 is positioned in the highest level of the hierarchical structure of the floor plan database 35a. Further, the schematic side views of the buildings 1a, 1b and the like are positioned in the level immediately below the level of the schematic plan view of the entire facility 1. Yet further, the schematic plan views of the unit spaces are positioned in the level immediately below the level of the schematic side views of the buildings 1a, 1b and the like (i.e., the lowest level).

The schematic plan views of the unit spaces are image data illustrating walls, pillars, doors, stairs and the like. Two dimensional coordinates are assigned to dots forming the schematic plan views of the unit spaces.

The floor plans, stored in the floor plan database 35a, are respectively provided with index information for indicating correspondence between the floor plans and the spaces. When integrated, the above index information produces information indicating the space structure of the facility 1 in the real world.

b) Fundamental Information Database

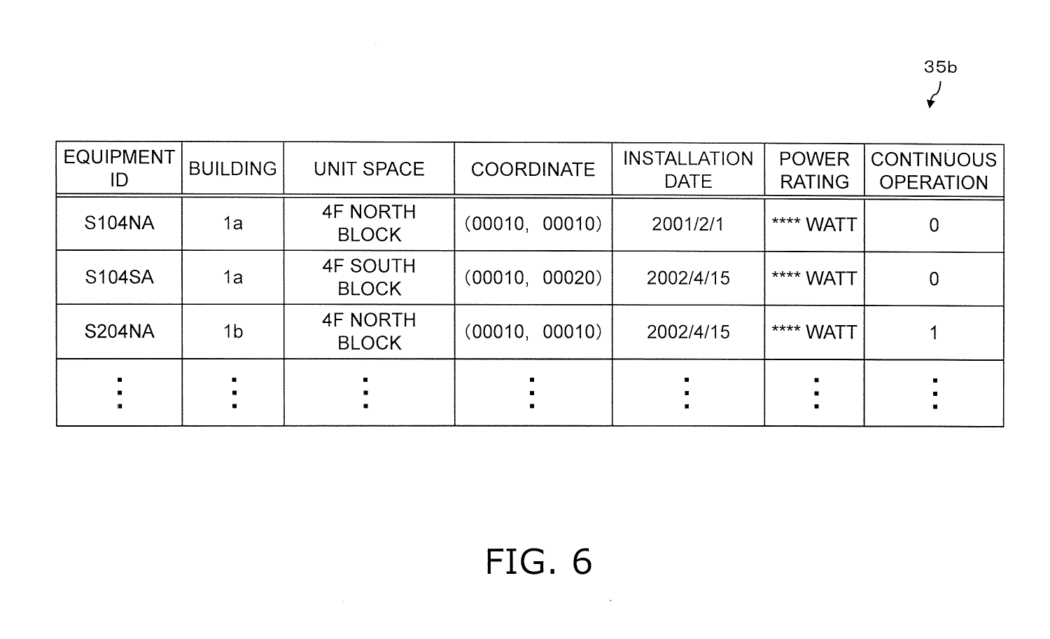

As illustrated in FIG. 6, the fundamental information database 35b is a table-formatted database including fields of “EQUIPMENT ID”, “BUILDING”, “UNIT SPACE”, “COORDINATE”, “INSTALLATION DATE”, “POWER RATING” and “CONTINUOUS OPERATION”.

Records stored in the fundamental information database 35b correspond to the indoor units 10a, 10b and the like included in the air-conditioning installation 10 on a one-to-one basis. Specifically, a single record includes the fundamental information (e.g., the positional information and the other attribute information) of a single indoor unit 10a, 10b or the like. The position of each indoor unit 10a, 10b or the like is specified by the combination of values of the fields of “BUILDING”, “UNIT SPACE” and “COORDINATE”.

The “EQUIPMENT ID” field stores the equipment IDs of the indoor units 10a, 10b and the like. The “BUILDING” field stores the names of the buildings 1a, 1b and the like in which the indoor units 10a, 10b and the like are installed. The “UNIT SPACE” field stores the names of the unit spaces in which the indoor units 10a, 10b and the like are installed. The “COORDINATE” field stores the coordinate information indicating the installation places of the indoor units 10a, 10b and the like based on the two dimensional coordinate assigned to the schematic plan views of the unit spaces.

The “INSTALLATION DATE” field stores the dates when the indoor units 10a, 10b and the like are installed in the facility 1. The “POWER RATING” field stores the power ratings of the indoor units 10a, 10b and the like. The “CONTINUOUS OPERATION” field stores a value “1” for each of the indoor units 10a, 10b and the like when continuous operation is required for a given indoor unit 10a, 10b or the like, for instance, due to the reason that the given indoor unit 10a, 10b or the like is installed in a computer server room, and otherwise stores a value “0” for the given indoor unit 10a, 10b or the like.

c) Operation Information Database

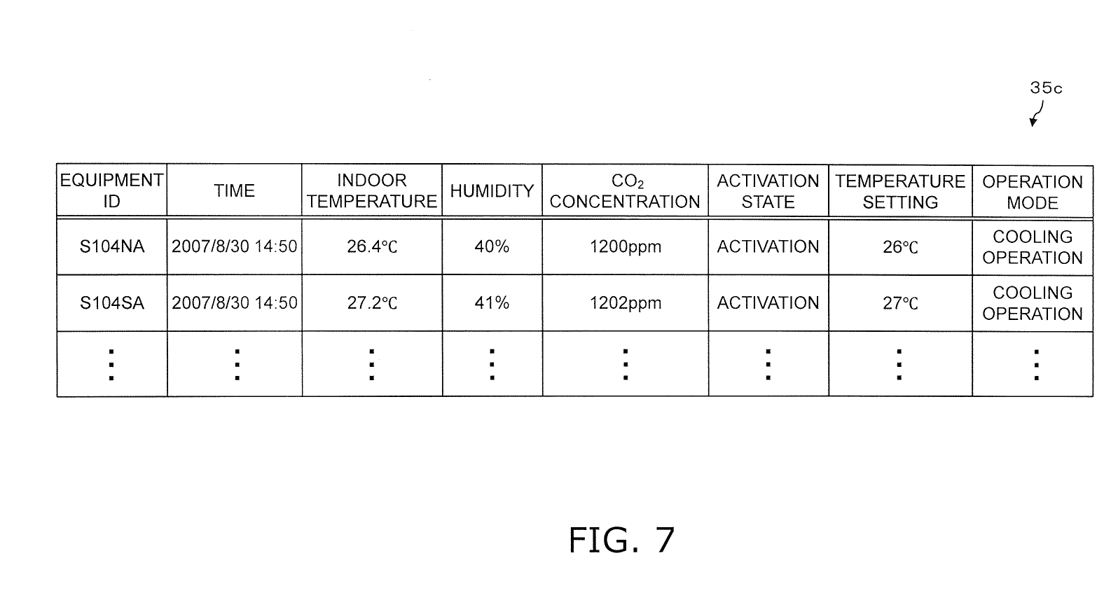

As illustrated in FIG. 7, the operation information database 35c is a table-formatted database including fields of “EQUIPMENT ID”, “TIME”, “INDOOR TEMPERATURE”, “HUMIDITY”, “CO₂ CONCENTRATION”, “ACTIVATION STATE”, “TEMPERATURE SETTING” and “OPERATION MODE”.

In the operation information database 35c, each record includes the operation information of each indoor unit 10a, 10b or the like at a given time (i.e., clock time).

The operation information database 35c is configured to be updated by the monitoring section 32a at predetermined time intervals (every one minute in the present exemplary embodiment). In other words, the monitoring section 32a is configured to receive the operation information of the indoor units 10a, 10b and the like through the child controllers 20a, 20b and the like at predetermined time intervals (every one minute in the present exemplary embodiment). The monitoring section 32a is configured to subsequently restructure the operation information in line with the data structure of the operation information database 35c and store the restructured operation information in the operation information database 35c as new records. It should be noted that the “TIME” field in each new record herein stores a clock time when the pre-restructured operation information is received.

d) Trouble History Database

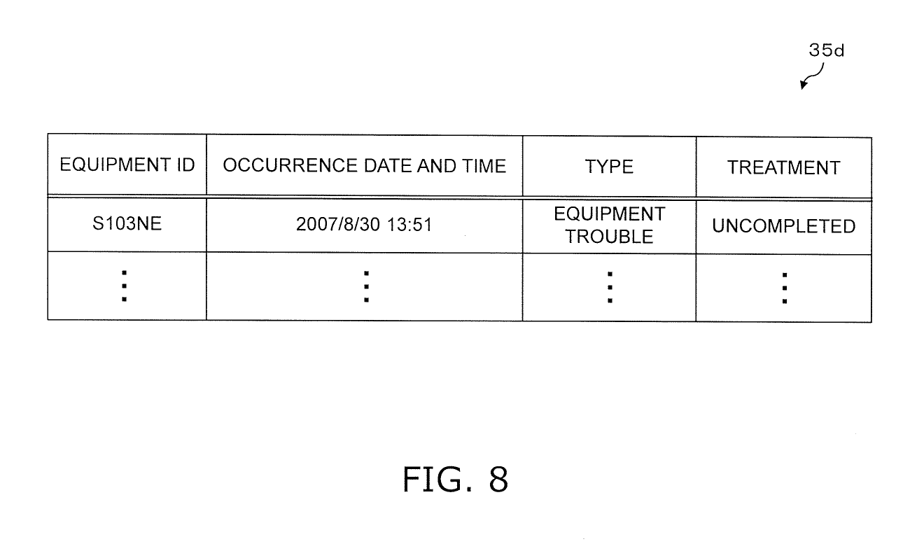

As illustrated in FIG. 8, the trouble history database 35d is a table-formatted database including fields of “EQUIPMENT ID”, “OCCURRENCE DATE AND TIME”, “TYPE” and “TREATMENT”.

When a given child controller 20a, 20b or the like informs the monitoring section 32a of a trouble occurred in a given indoor unit 10a, 10b or the like or a given outdoor unit, the monitoring section 32a is configured to create a new record corresponding to the trouble in the trouble history database 35d.

The “EQUIPMENT ID” field stores the equipment IDs of the indoor units 10a, 10b and the like or the outdoor units in which the troubles occurred. The “OCCURRENCE DATE AND TIME” field stores the dates and times when the troubles occurred. The “TYPE” field stores the types of the troubles. The “TREATMENT” field stores a value “COMPLETED” when an information input is received for indicating completion of treatment for the trouble, otherwise stores a value “UNCOMPLETED” until the information input is received.

(5) Management Screen

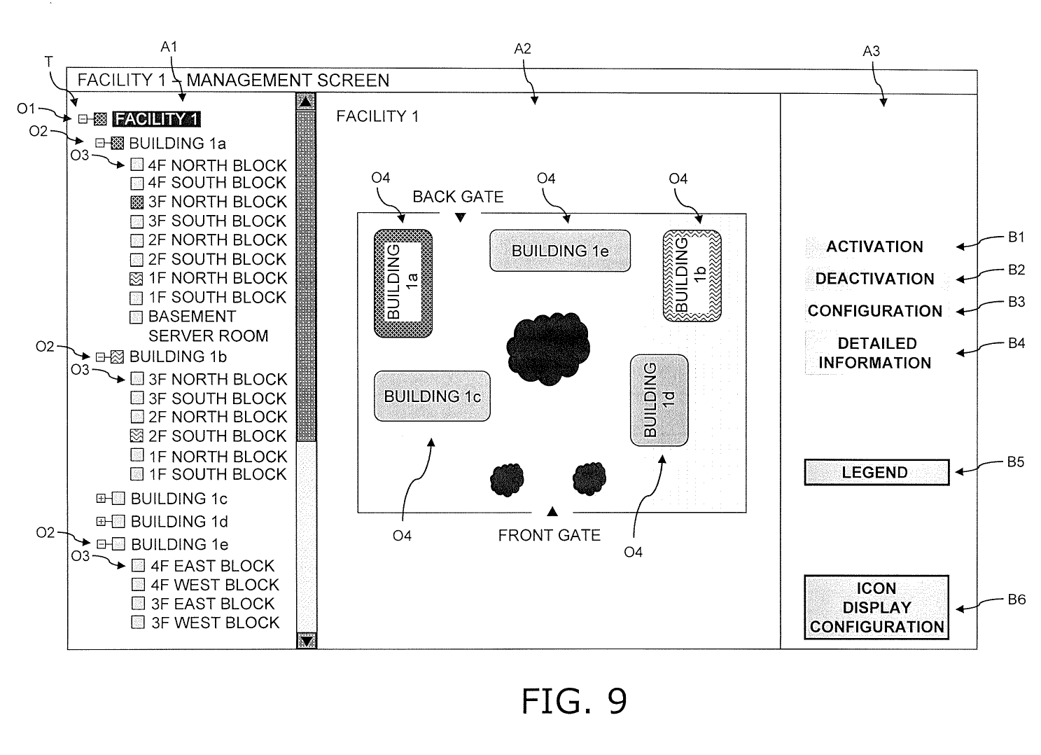

A management screen illustrated in FIGS. 9 to 11 is provided to the supervisory administrator for managing the indoor units 10a, 10b and the like. The management screen is created by the first display control section 32d, the second display control section 32e, and the third display control section 32f in the parent controller 3. The management screen is displayed on the display unit 33 of the parent controller 30.

The management screen is mainly divided into three frames A1 to A3. A tree structure T is displayed in the frame A1 arranged on the left side of the screen. A schematic view of the entire facility 1 or schematic views of spaces forming the facility 1 is/are displayed in the large frame A2 arranged on the middle of the screen. Various manipulation buttons B1 to B6 are displayed in the frame A3 arranged on the right side of the screen. The first display control section 32d is configured to control display of the frame A1 arranged on the left side of the screen. The second display control section 32e is configured to control display of the frame A2 arranged on the middle of the screen. The third display control section 32f is configured to control display of the frame A3 arranged on the right side of the screen.

a) Tree Structure

As illustrated in FIGS. 9 to 11, the tree structure T, displayed within the frame A1 arranged on the left side of the screen, is formed by vertically aligning a plurality of objects O1 to O3 in a tree shape. Each of the objects O1, O2 and O3 includes a square icon and characters. The icon and the characters are herein transversely aligned. More specifically, the tree structure T is formed as follows. The object O1, corresponding to the entire facility 1, is set to be a root object. The object O1 is branched into a plurality of the objects O2 corresponding to the buildings 1a, 1b and the like. Further, each of the objects O2 is branched into a plurality of the objects O3 corresponding to unit spaces. It should be noted that the objects O2 correspond to the buildings 1a, 1b and the like on a one-to-one basis, whereas the objects O3, branched from a given object O2, correspond to the unit spaces included in the building 1a, 1b or the like corresponding to the object O2 on a one-to-one basis. To form the tree structure T, the first display control section 32d is configured to look up the floor plan database 35a and position the objects O1 to O3 in line with the data structure of the floor plan database 35a.

Characters, included in each of the objects O1, O2 and O3, are determined based on the index information stored in the floor plan database 35a. Specifically, characters, included in the object O1 corresponding to the entire facility 1, are determined to be “FACILITY 1” based on the index information added to the floor plan of the entire facility 1. Characters, included in the object O2 corresponding to the building 1a, are determined to be “BUILDING 1a” based on the index information added to the floor plan of the building 1a. Characters, included in the object O3 corresponding to a unit space occupying the north block on the fourth floor of the building 1a, are determined to be “4F NORTH BLOCK” based on the index information added to the floor plan of the unit space occupying the north block on the fourth floor of the building 1a.

An icon, included in each of the objects O1, 2 and O3, is painted in different colors depending on the states of the indoor units 10a, 10b and the like included in the space corresponding to each of the objects O1, O2 and O3 (i.e., the entire facility 1, the buildings 1a, 1b and the like, and the unit spaces). It should be noted that the condition determination section 32c is configured to determine the state of each of the indoor units 10a, 10b and the like. The first display control section 32d is configured to determine a color to be painted on each icon depending on the determination result and change the color of each icon.

More specifically, the condition determination section 32c is configured to look up the fundamental information database 35b, the operation information database 35c and the trouble history database 35d at predetermined time intervals (every one minute in the present exemplary embodiment), and determine whether or not each of the indoor units 10a, 10b and the like satisfies the search conditions C1, C2 and the like stored in the storage unit 35. On the other hand, the first display control section 32d is configured to determine a color of the icon corresponding to each of the spaces (the entire facility 1, the buildings 1a, 1b and the like, and the unit spaces) at predetermined time intervals (every one minute in the present exemplary embodiment). Colors of the icons are determined by the following method. When at least a single indoor unit 10a, 10b or the like satisfies the search condition C1 in a space corresponding to a given icon, a first color is assigned to the icon. When at least a single indoor unit 10a, 10b or the like satisfies the search condition C2 but dissatisfying the search condition C1 in a space corresponding to a given icon, a second color is assigned to the icon. Simply put, different colors are preliminarily associated with the respective search conditions C1, C2 and the like. The respective icons are basically configured to be painted with a color corresponding to a satisfied one of the search conditions C1, C2 and the like. When two or more of the search conditions C1, C2 and the like are satisfied, however, the respective icons are configured to be painted with a color selected based on the priority order of the search conditions (i.e., sequentially C1, C2, and the like in this order). It should be noted that a default color is assigned to the icons when the search conditions C1, C2 and the like are all dissatisfied.

Only by watching the icons in the tree structure T, the supervisory administrator is allowed to promptly grasp facts such as troubles occurring in the indoor units 10a, 10b and the like within the spaces corresponding to the icons in the tree structure T (more specifically, whether or not at least a single indoor unit 10a, 10b or the like disposed in the respective spaces corresponding to the respective icons satisfies the search conditions C1, C2 and the like). It should be noted that the supervisory administrator is allowed to change, add and delete the search conditions C1, C2 and the like stored in the storage unit 35 through operation of the input unit 24 at an arbitrary timing. In other words, the supervisory administrator is allowed to freely configure the search conditions C1, C2 and the like for reflecting the facts that he/she wants to monitor in the colors of the icons.

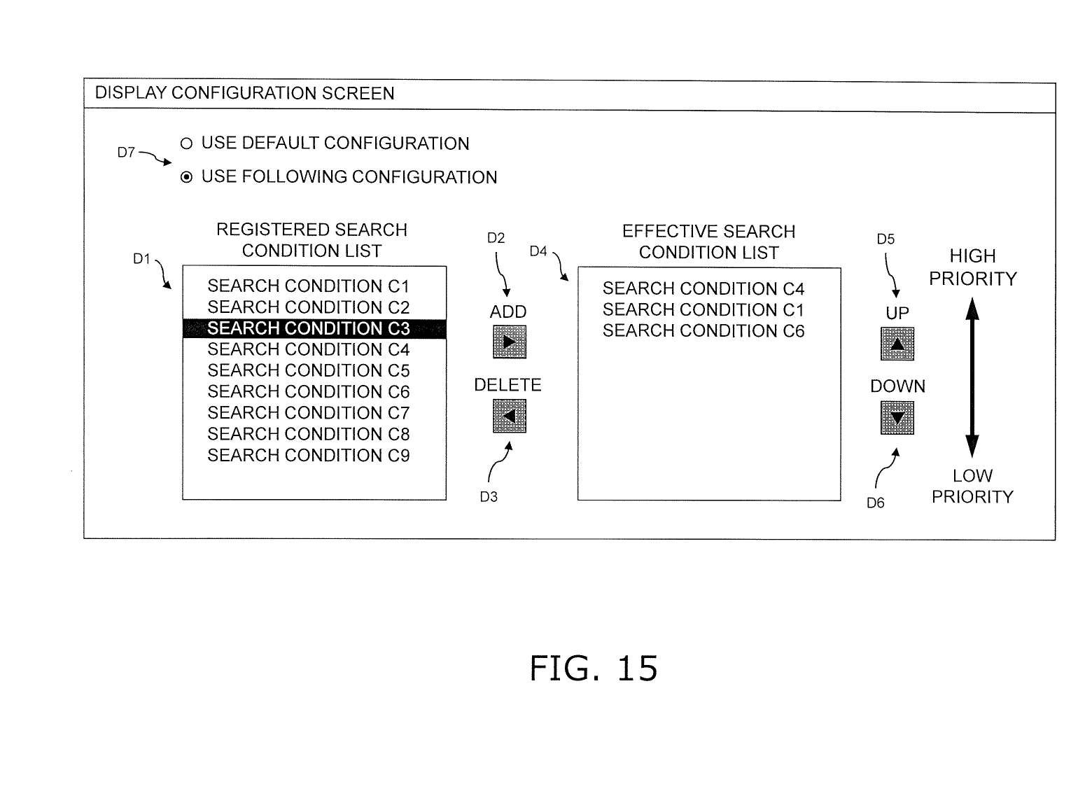

Through a display configuration screen illustrated in FIG. 15, the supervisory administrator is further allowed to change the priority order of the search conditions C1, C2 and the like to be considered in determining colors of the icons in the tree structure T. When an “ICON DISPLAY CONFIGURATION” button B6 is pressed, the display configuration screen is configured to be opened and disposed on the display unit 33. The button B6 is disposed on the bottom of the frame A3 arranged on the right side of the management screen illustrated in FIGS. 9 to 11.

Activation of some of the search conditions C1, C2 and the like, and determination of the priority order among the activated conditions selected from the search conditions C1, C2 and the like are received through the display configuration screen. It should be noted the term “activated” herein refers to a state that a condition is reflected in the colors of the icons corresponding to the objects O1 to O3.

The field of a registered search condition list D1 illustrated in FIG. 15 displays both of the default search conditions and the search conditions inputted by the supervisory administrator through another screen in a list format. When the supervisory administrator presses an “ADD” button D2 while selecting any one of the search conditions C1, C2 and the like that he/she wants to activate from the registered search condition list D1, the selected condition is added to the end of an effective search condition list D4. When the supervisory administrator presses a “DELETE” button D3 while selecting any one of the search conditions C1, C2 and the like listed in the effective search condition list D4, on the other hand, the selected condition is deleted from the effective search condition list D4.

The search conditions C1, C2 and the like are ordered from top to bottom in the effective search condition list D4 based on a descending priority order. The order is configured to be changed by manipulating an “UP” button D5 and a “DOWN” button D6. More specifically, when a position of a given search condition in the priority order is desired to be raised in the effective search condition list D4, the “UP” button D5 is required to be pressed while the search condition is selected. When the position of a given search condition in the priority order is desired to be lowered, on the other hand, the “DOWN” button D6 is required to be pressed while the search condition is selected. Every time either the “UP” button D5 or the “DOWN” button D6 is pressed once, the priority order for a selected search condition is raised or lowered by one. It should be noted that the “UP” button D5 and the “DOWN” button D6 are configured to be deactivated when only a single search condition is listed in the effective search condition list D4 because determination of the priority order is unnecessary.

The information, edited by the supervisory administrator through the display configuration screen, is stored in the storage unit 35 while being associated with main data of the search conditions C1, C2 and the like. The information, edited by the supervisory administrator through the display configuration screen, herein refers to information indicating activated condition/conditions selected from the registered search conditions C1, C2 and the like and information indicating the priority order among the activated conditions. The information stored in the storage unit 35 is updated every time the supervisory administrator edits the search conditions C1, C2 and the like displayed in the field of the effective search condition list D4 through the display configuration screen.

It should be noted that the buttons D2, D3, D5 and D6 of “ADD”, “DELETE”, “UP” and “DOWN” are allowed to be manipulated only when one of the radio buttons D7 “USE FOLLOWING CONFIGURATION” is selected. The radio buttons D7 are herein disposed on the top of the display configuration screen. When the other of the radio buttons D7 “USE DEFAULT CONFIGURATION” is selected, in contrast, predetermined search conditions C1, C2 and the like are displayed in the field of the effective search condition list D4 in a predetermined order. Further, the priority order of the predetermined search conditions C1, C2 and the like is set in this order for determining colors of the icons disposed in the tree structure T.

When only one search condition is activated, the first display control section 32d is configured to paint the icons, corresponding to the spaces (the entire facility 1, the buildings 1a, 1b and the like, and the unit spaces) including at least one of the indoor unit 10a, 10b or the like satisfying the search condition, with a color corresponding to the search condition. When two or more search conditions are activated and two or more of the activated conditions are simultaneously satisfied by at least one of the indoor units 10a, 10b and the like included in an identical space (i.e., the entire facility 1, any of the buildings 1a, 1b and the like, or any of the unit spaces), the icon corresponding to the space is painted with a color corresponding to a highest-prioritized one of the satisfied search conditions. The aforementioned case that “two or more of the activated conditions are simultaneously satisfied by at least one of the indoor units 10a, 10b and the like included in an identical space” includes both of the following cases. One is that a single indoor unit simultaneously satisfies a plurality of search conditions. The other is that a given indoor unit satisfies a given search condition while another indoor unit satisfies another search condition.

Further, each of the search conditions C1, C2 and the like is a combination of an extraction condition and an exclusion condition (this is optional). The phrase “a given search condition C1, C2 or the like is satisfied” refers to a condition that the exclusion condition of the given search condition C1, C2 or the like is dissatisfied but the extraction condition of the given search condition C1, C2 or the like is satisfied.

In the search condition C1, the exclusion condition is omitted and thus occurrence of a trouble is set as an extraction condition. Therefore, the supervisory administrator is allowed to check troubles in the indoor units 10a, 10b and the like with reference to the colors of the icons. It should be noted that the condition determination section 32c is configured to determine whether or not a given indoor unit 10a, 10b or the like satisfies the search condition C1 with reference to the trouble history database 35d.

For example, the following conditions are set as the other search conditions C2 and the like.

As a first example, “a temperature setting of greater than 25 degrees Celsius” is set as an exclusion condition, whereas a pair of “an indoor temperature of less than or equal to 25 degrees Celsius” and “a currently operated indoor unit” is set as an extraction condition. By watching the colors of the icons, it is herein possible to confirm if a single or plurality of the indoor units 10a, 10b and the like is/are still operated without being turned off under the condition that the temperature setting is set to be low (i.e., less than or equal to 25 degrees Celsius) and the actual indoor temperature is excessively lowered (i.e., less than or equal to 25 degrees Celsius). It should be noted that the condition determination section 32c is configured to determine whether or not a given indoor unit 10a, 10b or the like satisfy the search condition with reference to the values of the fields of “EQUIPMENT ID”, “TIME”, “INDOOR TEMPERATURE”, “TEMPERATURE SETTING” and “ACTIVATION STATE” in the operation information database 35c.

Next, as a second example, “installation date within five years” is set as an exclusion condition, whereas “a currently operated indoor unit” is set as an extraction condition. By watching the colors of the icons, it is herein possible to confirm if an old indoor unit/units installed five or more years ago, included in the indoor units 10a, 10b and the like, is/are still operated without being turned off. It should be noted that the condition determination section 32c is configured to determine whether or not a given indoor unit 10a, 10b or the like satisfies the search condition with reference to the values of the fields of “EQUIPMENT ID” and “INSTALLATION DATE” in the fundamental information database 35b and the values of the fields of “EQUIPMENT ID”, “TIME” and “ACTIVATION STATE” in the operation information database 35c.

Further, as a third example, “a power rating of less than or equal to a predetermined value” is set as an exclusion condition, whereas “a currently operated indoor unit” is set as an extraction condition. By watching the colors of the icons, it is herein possible to confirm whether or not a large power consuming indoor unit/units, included in the indoor units 10a, 10b and the like, is/are currently operated without being turned off. It should be noted that the condition determination section 32c is configured to determine whether or not a given one of the indoor units 10a, 10b and the like satisfies the search condition with reference to the values of the fields of “EQUIPMENT ID” and “POWER RATING” in the fundamental information database 35b and the values of the fields of “EQUIPMENT ID”, “TIME” and “ACTIVATION STATE” in the operation information database 35c.

Further, as a fourth example, “an indoor unit for a non-continuous operation use” is set as an exclusion condition, whereas “a currently deactivated indoor unit” is set as an extraction condition. By watching the colors of the icons, it is herein possible to confirm if a single or plurality of the indoor units 10a, 10b and the like, required to be continuously operated (e.g., an indoor unit in the computer server room), is/are currently deactivated. It should be noted that the condition determination section 32c is configured to determine whether or not a given one of the indoor units 10a, 10b and the like satisfies the search condition with reference to the values of the fields of “EQUIPMENT ID” and “CONTINUOUS OPERATION” in the fundamental information database 35b and the values of the fields of “EQUIPMENT ID”, “TIME” and “ACTIVATION STATE” in the operation information database 35c.

Further, as a fifth example, “a registered operation schedule” is set as an exclusion condition, whereas “a currently operated indoor unit” is set as an extraction condition. By watching the colors of the icons, it is herein possible to confirm if a single or plurality of the indoor units 10a, 10b and the like is/are still operated without being turned off against intension of the supervisory administrator. It should be noted that the condition determination section 32c is configured to determine whether or not a given indoor units 10a, 10b or the like satisfies the search condition with reference to the information regarding the operation schedule stored within the storage unit 35 and the values of the fields of “EQUIPMENT ID”, “TIME” and “ACTIVATION STATE” in the operation information database 35c.

Further, an open/close button is disposed on the left of each of the objects O1 and O2 excluding the objects disposed in the bottom layer of the tree structure T. When the open/close button is set to be in a state “+”, this means that objects on the right of each of the objects O1 and O2 (i.e., objects disposed in a layer immediately below the layer of each of the objects O1 and O2 in the tree structure T) is not currently displayed. When the open/close button is set to be in a state “−”, in contrast, this means that objects on the right of each of the objects O1 and O2 (i.e., objects disposed in a layer immediately below the layer of each of the objects O1 and O2 in the tree structure T) is currently displayed.

b) Schematic Views of Entire Facility 1 and Spaces Forming Facility 1

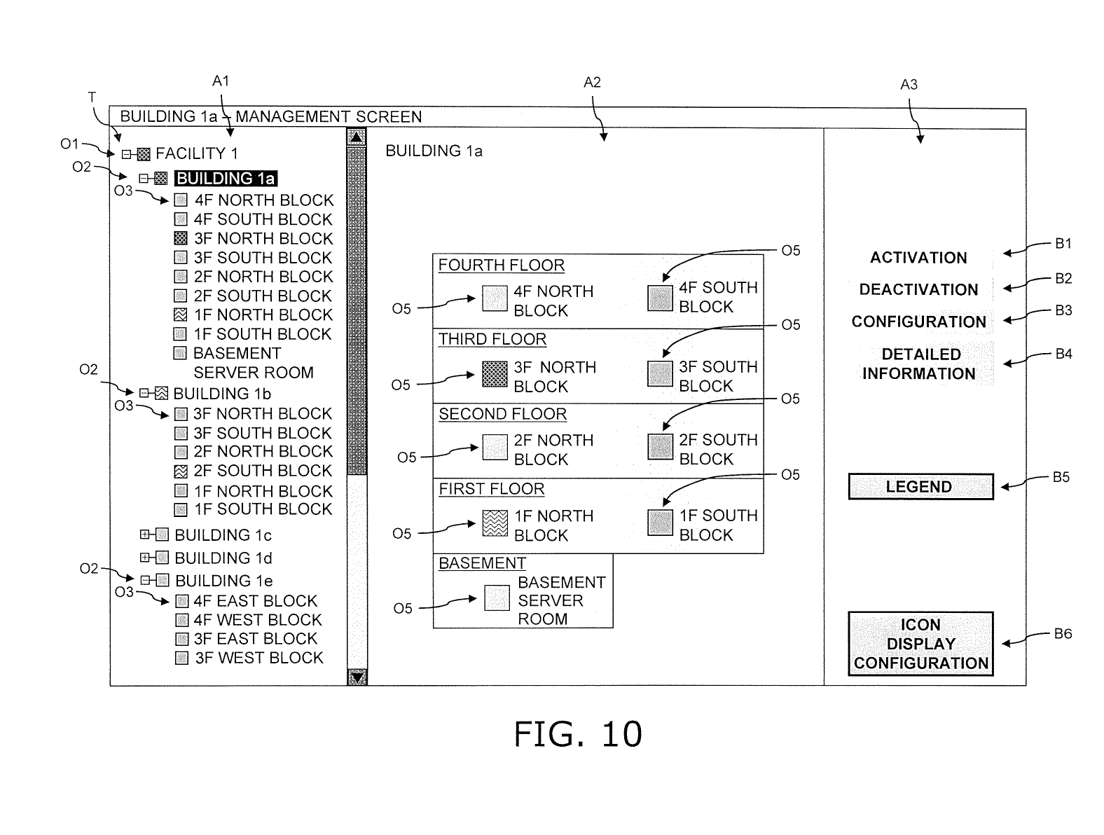

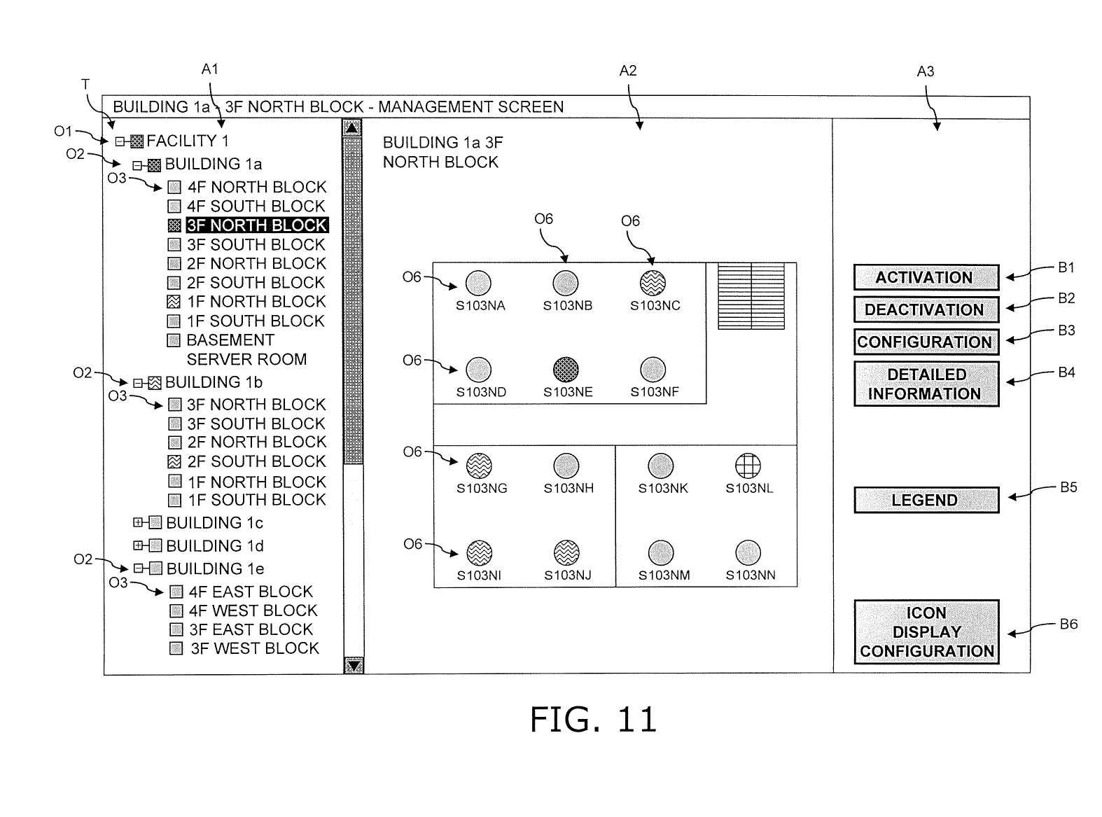

As illustrated in FIGS. 9 to 11, a schematic view of a currently selected space (i.e., any of the entire facility 1, the buildings 1a, 1b and the like, and the unit spaces) is displayed in the frame A2 arranged on the middle of the screen in response to operation by the supervisory administrator through the input unit 34. FIG. 9 is an exemplary screen to be displayed while the entire facility 1 is selected. FIG. 10 is an exemplary screen to be displayed while the building 1a is selected. FIG. 11 is an exemplary screen to be displayed while the north block on the third floor of the building 1a is selected as a unit space.

b-1) Schematic View of Entire Facility

When detecting that the object O1, corresponding to the entire facility 1, is selected in the tree structure T, the second display control section 32e is configured to extract a floor plan of the space corresponding to the object O1 (i.e., a schematic plan view of the entire facility 1) from the floor plan database 35a and display the extracted floor plan in the frame A2 as illustrated in FIG. 9.

Portions, corresponding to the buildings 1a, 1b and the like, are displayed as objects O4 in the schematic plan view of the entire facility 1. Colors of the objects 4 are configured to be changed depending on conditions of the indoor units 10a, 10b and the like in the buildings 1a, 1b and the like. The objects O4 displayed in the frame A2, corresponding to the buildings 1a, 1b and the like, are painted with the same colors as the objects O2 corresponding to the buildings 1a, 1b and the like in the tree structure T.

b-2) Schematic Views of Buildings

When detecting that a given object O2, corresponding to a given building 1a, 1b or the like, is selected in the tree structure T, the second display control section 32e is configured to extract a floor plan of the space corresponding to the object O2 (i.e., a schematic side view of the building 1a, 1b or the like) from the floor plan database 35a and display the extracted floor plan in the frame A2 as illustrated in FIG. 10. It should be noted that the schematic side view of a given building 1a, 1b or the like is configured to be displayed in the frame A2 when the object O4, corresponding to the building 1a, 1b or the like, is selected while the schematic view of the entire facility 1 is displayed in the frame A2.

Portions, corresponding to the unit spaces of a building 1a, 1b or the like, are displayed as objects O5 in the schematic side view of the building 1a, 1b or the like. Colors of the objects O5 are configured to be changed depending on the conditions of the indoor units 10a, 10b and the like in the unit spaces. The objects O5 displayed in the frame A2, corresponding to the unit spaces, are painted as the same colors as the objects O3 corresponding to the unit spaces in the tree structure T.

b-3) Schematic Views of Unit Spaces

When detecting that a given object O3, corresponding to a given unit space, is selected in the tree structure T, the second display control section 32e is configured to extract a floor plan corresponding to the selected object O3 (i.e., a schematic plan view of the unit space) from the floor plan database 35a and display the extracted floor plan in the frame A2 as illustrated in FIG. 11. It should be noted that the schematic plan view of a given unit space is configured to be displayed in the frame A2 when the object O5, corresponding to the unit space, is selected while a schematic view of a given building 1a, 1b or the like is displayed in the frame A2.

Further, the second display control section 32e is configured to dispose the objects O6, corresponding to the indoor units 10a, 10b and the like disposed in the selected unit space, on the schematic plan view of the selected unit space displayed in the frame A2. More specifically, the second display control section 32e is configured to search through the fundamental information database 35b and extract a single or plurality of records containing information to specify the currently selected unit space in the fields of “BUILDING” and “UNIT SPACE”. The second display control section 32e is then configured to dispose a single or plurality of the objects O6 in line with the value/values of the “COORDINATE” field/fields of the extracted record/records.

Each object O6 includes an icon and characters.

The characters, included in each object O6, are set as a value of the field of “EQUIPMENT ID” in a record corresponding to each object O6 within the fundamental information database 35b.

Meanwhile, the icon, included in each object O6, is configured to be painted in different colors depending on the state of each indoor unit 10a, 10b or the like corresponding to each object O6. The colors of the icons in the frame A2 are configured to be determined similarly to the method adopted by the first display control section 32d for determining the colors to be assigned to the icons in the tree structure T.

Specifically, the second display control section 32e is configured to determine the colors of the icons included in the respective objects O6 depending on the determination result of the condition determination section 32c at predetermined time intervals (every one minute in the present exemplary embodiment). Colors of the icons included in the respective objects O6 are determined in the following method. When the search condition C1 is satisfied by a given indoor unit 10a, 10b or the like corresponding to the icon included in a given object O6, a first color is assigned to the icon. When the search condition C1 is dissatisfied but the search condition C2 is satisfied, a second color is assigned to the icon. When the search conditions C1, C2 and the like are all dissatisfied, the default color is assigned to the icon. Similarly to determination of the colors of the icons included in the tree structure T, the supervisory administrator is allowed to set the priority order among the search conditions C1, C2 and the like through the display configuration screen illustrated in FIG. 15.

Overall, only by watching the icons in the frame A2, the supervisory administrator can promptly grasp facts such as troubles occurring in the indoor units 10a, 10b and the like corresponding to the icons (more accurately, whether or not the indoor units 10a, 10b and the like corresponding to the icons satisfy the search conditions C1, C2 and the like).

c) Manipulation Buttons

As illustrated in FIGS. 9 to 11, a plurality of the manipulation buttons B1 to B5 is displayed in the frame A3 arranged on the right side of the screen. The manipulation buttons B1 to B4 are configured to be deactivated while the schematic view of the entire facility 1 or the building 1a, 1b or the like is displayed in the frame A2. However, the manipulation buttons B1 to B4 are configured to be activated while the schematic view of a given unit space is displayed in the frame A2.

While the schematic view of the unit spaces is displayed in the frame A2, the supervisory administrator is allowed to select one of the objects O6 on the schematic view through the input unit 34.

When the supervisory administrator presses the “ACTIVATION” button B1 while a given object O6 is selected, the operation control section 32b is configured to transmit an operation command to the control unit 12 of the indoor unit 10a, 10b or the like corresponding to the given object O6 through the child controller 20a, 20b of the like responsible for controlling of the indoor unit 10a, 10b or the like in order to cause the control unit 12 to activate the indoor unit 10a, 10b or the like. Therefore, the supervisory administrator is allowed to easily activate the indoor units 10a, 10b and the like through the management screen.

Similarly, when the supervisory administrator presses the “DEACTIVATION” button B2 while a given object O6 is selected, the operation control section 32b is configured to transmit an operation command to the control unit 12 of the indoor unit 10a, 10b or the like corresponding to the given object O6 through the child controller 20a, 20b or the like responsible for controlling of the indoor unit 10a, 10b or the like in order to cause the control unit 12 to deactivate the indoor unit 10a, 10b or the like. Therefore, the supervisory administrator is allowed to easily deactivate the indoor units 10a, 10b and the like through the management screen.

When the supervisory administrator presses the “CONFIGURATION” button B3 while a given object O6 is selected, on the other hand, a configuration change window is configured to be displayed on the display unit 33 for receiving changes of the operation parameters (e.g., temperature setting and operation mode) of the indoor unit 10a, 10b or the like corresponding to the given object O6. When an operation parameter is changed through the configuration change window, the operation control section 32b is configured to transmit an operation command to the control unit 12 of the indoor unit 10a, 10b or the like through the child controller 20a, 20b or the like responsible for controlling of the indoor unit 10a, 10b or the like in order to cause the control unit 12 to change the operation parameter. Therefore, the supervisory administrator is allowed to easily change the operation parameters of the indoor units 10a, 10b and the like through the management screen.

When the supervisory administrator presses the “DETAILED INFORMATION” button B4 while a given object O6 is selected, on the other hand, a detailed information window is configured to be displayed on the display unit 33 for displaying the detailed information of the indoor unit 10a, 10b or the like corresponding to the given object O6. The detailed information window displays the information related to the indoor unit 10a, 10b or the like including the fundamental information stored in the fundamental information database 35b, the operation information stored in the operation information database 35c, the trouble information stored in the trouble history database 35d, and the like. Further, the detailed information window is also configured to be displayed when a given object O6 is selected with a predetermined method (e.g., double-clicking of the mouse of the input unit 34). The supervisory administrator is thus allowed to easily access the detailed information of the indoor units 10a, 10b and the like through the management screen.

Further, when the supervisory administrator presses the “LEGEND” button B5 through the input unit 34, a legend display window is configured to be opened and displayed on the display unit 33 for displaying legends of colors to be assigned to the respective objects O1 to O6 or the icons included therein. Therefore, the supervisory administrator is allowed to easily grasp the meanings of the colors of the objects O1 to O6 or the icons included therein.

(6) Control Logic

The control logics L1, L2 and the like are stored in the storage unit 35 of the parent controller 30. The entities of the control logics L1, L2 and the like are programs to be triggered by signals outputted from the condition determination section 32c. The programs are stored in the storage unit 35 while being associated with the types of the signals triggering activation of the programs. It should be noted that each of the control logics L1, L2 and the like is allowed to be associated with a single or plural types of the signal.

As described above, the condition determination section 32c is configured to determine whether or not each indoor unit 10a, 10b or the like satisfies the search conditions C1, C2 and the like stored in the storage unit 35 with reference to the databases 35b to 35d at predetermined time intervals. Further, every time determining that a given indoor unit 10a, 10b or the like satisfies a given search condition C1, C2 or the like, the condition determination section 32c is configured to output signals indicating the determination result to the logic execution section 32g. Specifically, the signals include information for specifying the given indoor unit 10a, 10b or the like and information for specifying the given search condition C1, C2 or the like. On the other hand, every time receiving the signals, the logic execution section 32g is configured to confirm whether or not the storage unit 35 stores a given control logic L1, L2 or the like to be triggered by the signals. When confirming that the storage unit 35 stores such a control logic L1, L2 or the like, the logic execution section 32g is configured to execute the control logic L1, L2 or the like.

For example, the control logics L1, L2 and the like include the following types.

A first exemplary control logic is configured to cause a sound output unit (not illustrated in the figure) of the parent controller 30 to output a buzz sound in conjunction with receipt of signals indicating that a specific indoor unit 10a, 10b or the like satisfies a specific search condition C1, C2 or the like (e.g., occurrence of a trouble).

Further, a second exemplary control logic is configured to transmit e-mails to preliminarily registered e-mail addresses in conjunction with receipt of signals indicating that a specific indoor unit 10a, 10b or the like satisfies a specific search condition C1, C2 or the like (e.g., occurrence of a trouble). When the registered e-mail addresses include the e-mail address of the administrator in charge of the building 1a, 1b or the like that the specific indoor unit 10a, 10b or the like is installed, it is possible to promptly inform the administrator of a fact such as a trouble occurring in the indoor unit 10a, 10b or the like (more accurately, the fact that the indoor units 10a, 10b or the like satisfies the search condition C1, C2 or the like).

Yet further, a third exemplary control logic is configured to execute a demand inhibition control in conjunction with receipt of signals indicating that a specific indoor unit 10a, 10b or the like satisfies a specific search condition C1, C2 or the like (e.g., the fact that temperature setting is out of a predetermined temperature range).

<Features>

(1)

In the aforementioned exemplary embodiment, the facility 1 is configured to be expressed by the tree structure T including the following components: the object O1 corresponding to the entire facility 1; the objects O2 corresponding to the buildings 1a, 1b and the like; and the objects O3 corresponding to the unit spaces. Further, the colors of the objects O1 to O3 are configured to be changed depending on the states of the indoor units 10a, 10b and the like within the spaces corresponding to the respective objects O1 to O3. Therefore, the supervisory administrator is allowed to intuitively understand the states of the indoor units 10a, 10b and the like with reference to the visual aspects of the objects O1 to O3.

(2)

In the aforementioned exemplary embodiment, the schematic view of the space currently selected in the tree structure T (i.e., the entire facility 1, any of the buildings 1a, 1b and the like, or any of the unit spaces) is configured to be displayed with the tree structure T. Therefore, the supervisory administrator is allowed to easily select his/her desired space through the tree structure T and intuitively understand the state of the space currently selected through the schematic view.

(3)

In the aforementioned exemplary embodiment, the objects O6, displayed on the schematic view (see FIG. 11) of each unit space, are set as links to the detailed information of the indoor units 10a, 10b and the like corresponding to the objects O6. Therefore, the supervisory administrator is allowed to easily access the detailed information of the indoor units 10a, 10b and the like.

(4)

In the aforementioned exemplary embodiment, the supervisory administrator is allowed to freely define the priority order among the plural search conditions C1, C2 and the like for determining the colors of the icons included in the objects O1 to O6 through the display configuration screen.

Therefore, the supervisory administrator is required to activate only the search condition C1, for instance, when he/she wants to confirm only occurrence of troubles.

Further, the following monitoring is executable when “a currently operated indoor unit” is set as the second condition C2 whereas a pair of “a temperature setting of lower than the standard temperature value” and “a currently operated indoor unit” is set as the search condition C3.

When only the search condition C2 is herein activated, only the following icons are configured to be painted in different colors: icons corresponding to the currently operated indoor units included in the indoor units 10a, 10b and the like; or the icons corresponding to the spaces that the currently operated indoor units included in the indoor units 10a, 10b and the like are installed. The supervisory administrator is thereby allowed to easily judge that a given indoor unit 10a, 10b or the like is currently operated without being turned off or judge that a given space includes one or more indoor units 10a, 10b and/or the like currently operated without being turned off.

Further, when the search conditions C1 to C3 are all activated and the following priority order is set: C1>C2>C3, it is possible to monitor all of the following: occurrence of a trouble; an indoor unit currently operated without being turned off; and an inappropriate temperature setting. More specifically, when a trouble occurs, this is reflected in the display formats of the objects O1 to O6 as the top priority. Next, existence of a wasteful power consuming indoor unit included in the indoor units 10a, 10b and the like is reflected in the display formats of the objects O1 to O6.

Simply put, in the aforementioned exemplary embodiment, a display format is configured to be freely switched depending on a monitoring purpose of the supervisory administrator.

<Modifications>

(1)

In the aforementioned exemplary embodiment, the facility 1 is hierarchically structured as a space organized by three layers in accordance with management executed by the parent controller 30. However, the facility 1 may be structured as a space organized by two layers or four or more layers.

(2)

In the aforementioned exemplary embodiment, the parent controller 30 may be configured to provide the aforementioned management screen and the display configuration screen to a client computer configured to use the parent controller 30 as a server computer. Further, the client computer may be a terminal device disposed within the LAN 5a or a terminal device disposed outside the LAN 5a (e.g., a remote terminal device that is disposed outside the facility 1 and configured to be connected to the server computer through the Internet). When the parent controller 30 herein has a web server function, a terminal having a browsing function may be used as the client computer.

Further, in the present modification, each of user IDs authorized to log in the parent computer 30 (alternatively, each of the client computers) may be allowed to execute activation of the search conditions C1, C2 and the like and determination of the priority order of the activated search conditions C1, C2 and the like. For example, when an administrator herein edits information through the display configuration screen using the console of parent controller 30 or the client computer, the edited information is stored in a database in the storage unit 35 while being associated with both of the user ID and the main data of the search conditions C1, C2 and the like. When receiving a request of displaying the management screen and the display configuration screen, parent controller 30 specifies the user ID of the access source and displays a screen based on the information associated with the user ID within the database.

Excluding the parent controller 30, the terminal devices are herein allowed to monitor the indoor units 10a, 10b and the like. Further, when a plurality of administrators exists, each administrator is allowed to display the screen in the format matched with his/her preference.

(3)

In the aforementioned exemplary embodiment, the colors of the objects O1 to 6 are configured to be changed depending on the states of the indoor units 10a, 10b and the like. However, not only the colors, but also shapes, patterns and combinations thereof may be configured to be changed.

(4)

In the aforementioned exemplary embodiment, the search conditions C1, C2 and the like are configured to be set as needed. Only either of the extraction condition and the exclusion condition may be configured to be changed.

(5)

In the aforementioned exemplary embodiment, the parent controller 30 may be connected to a remote management server installed in a service center and the like disposed away from the facility 1 through the Internet and the like. Further, various plural controllers, installed in a plurality of facilities excluding the facility 1, may be configured to be connected to the remote management server.

(6)

In the aforementioned exemplary embodiment, the child controllers 20a, 20b and the like may not be used. Specifically, the indoor units 10a, 10b and the like may be directly connected to the parent controller 30 without intervention of the child controllers 20a, 20b and the like. In this case, the parent controller 30 may be in charge of all or a part of processing to be executed by the child controllers 20a, 20b and the like.

(7)

In the aforementioned exemplary embodiment, the group management system 100 may be configured to manage equipments of another type excluding the equipments of the air-conditioning installation. For example, the equipments of another type may be any of the group of: the lighting devices; the water supply/drainage devices; the humidifiers; the elevators; and the security devices. Further, the group management system 100 may be configured to manage equipments of plural types including or not including the equipments of the air-conditioning installation.

In this case, for instance, the respective search conditions C1, C2 and the like may be set to have the following configuration. Simply put, “equipment of a specific type” is set as an exclusion condition whereas “currently operated equipment” is set as an extraction condition. Under the search conditions C1, C2 and the like, it is possible to confirm whether or not only the equipment of a specific type is currently operated without being turned off with reference to the colors of the icons. For setting the search conditions C1, C2 and the like as described above, for instance, predetermined fields (e.g., the “TYPE” field for storing a value indicating an equipment type) are required to be defined in the fundamental information database 35b.

(8)

In the aforementioned exemplary embodiment, the outdoor units may be configured to be managed through the management screen similarly to the indoor units 10a, 10b and the like.

(9)

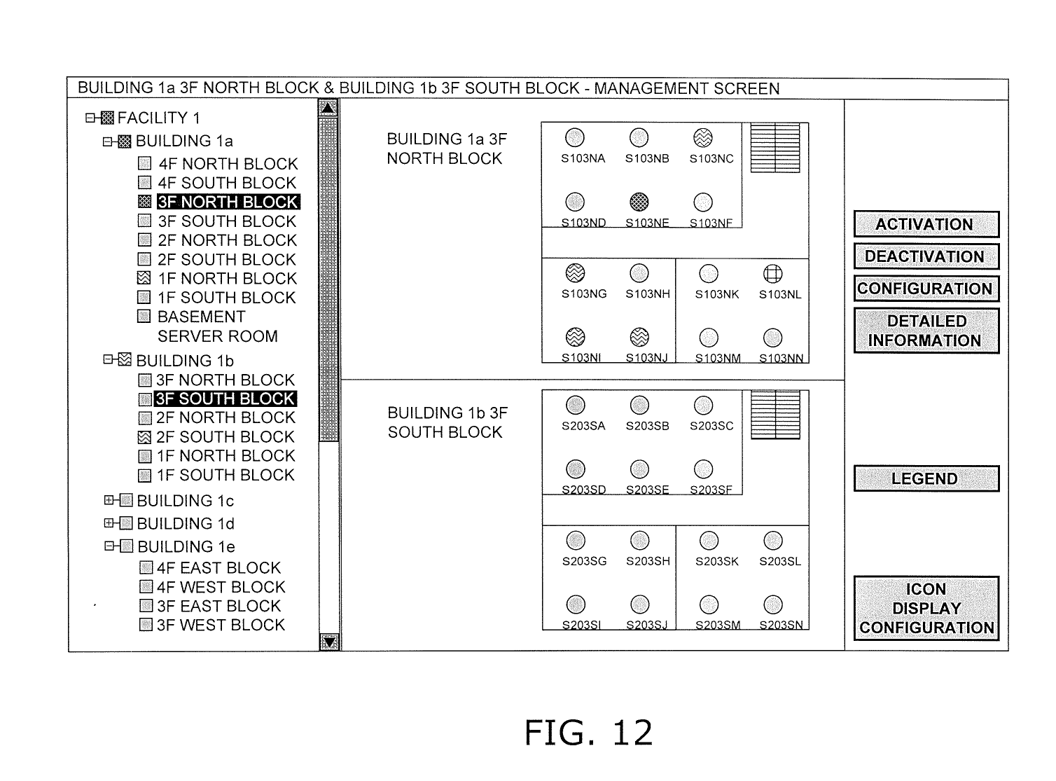

In the aforementioned exemplary embodiment, only one of the objects O1 to O3 is allowed to be selected at the same time in the tree structure T displayed in the frame A1. However, a plurality of objects may be allowed to be selected from the objects O1 to O3 at the same time and the schematic views corresponding to the simultaneously selected plural objects O1 to O3 may be aligned and displayed in the frame A2 (see FIG. 12).

In this case, the respective schematic views are displayed in relatively small sizes within the frame A2. Therefore, it is preferable to provide a “magnifier” function for partially enlarging the schematic views.

Further, a variety of methods can be adopted for selecting a plurality of objects at the same time. For example, an area, containing desired plural objects of the objects O1 to O3, may be dragged in a rectangular shape with the mouse of the input unit 34.

(10)

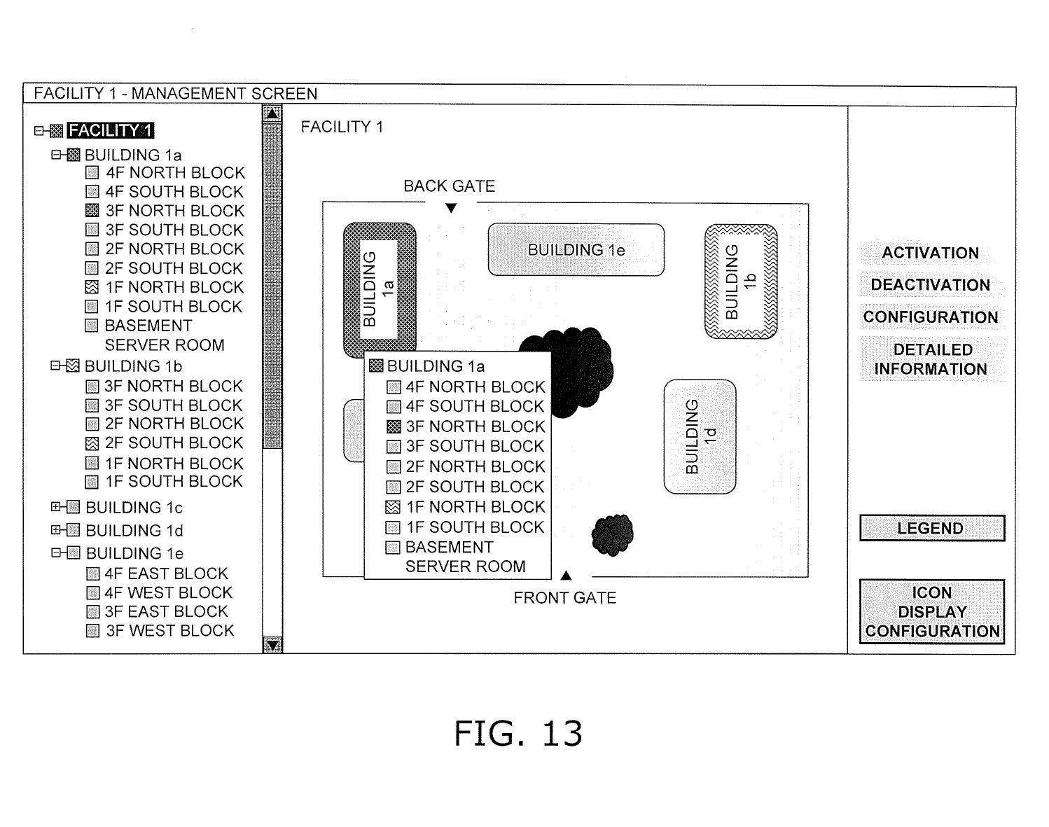

In the aforementioned exemplary embodiment, when a predetermined manipulation is executed for a given object O4 on the schematic view (e.g., when the right button of the mouse of the input unit 34 is clicked while the cursor of the mouse is pointed the object 4) while the schematic view of the buildings 1a, 1b and the like is displayed in the second frame A2, a tree structure, indicating the structure of the space corresponding to the object O4, may be configured to be displayed in the vicinity of the object O4 (see FIG. 13).

Further, the tree structure, herein displayed anew, may have the same visual aspect as a portion cut out of the tree structure in the frame A1. Objects, as components of the newly displayed tree structure, may be herein configured to be selected.

(11)

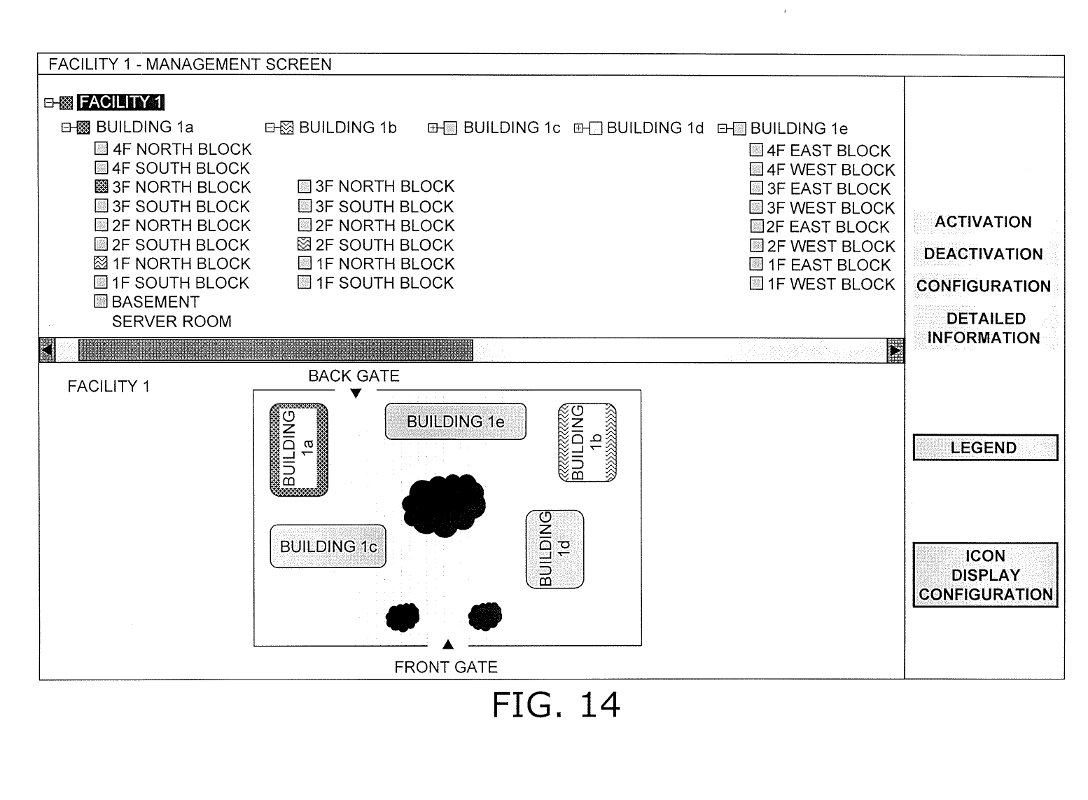

In the aforementioned exemplary embodiment, the tree structure T is configured to be opened in a vertically elongated shape. However, the tree structure T may be configured to be opened in a transversely elongated shape (see FIG. 14). In this case, chances are high that the tree structure is fully displayed in a single screen. This is because the displays of the personal computers normally have a transversely elongated design.

(12)

Information, obtained and stored by the parent controller 30 and the child controllers 20a, 20b and the like, is not limited to the information described in the aforementioned exemplary embodiment.

For example, the parent controller 30 may be configured to obtain a variety of information (e.g., frequency of a compressor, revolution of a fan, temperature and pressure of a refrigerant in a given position within a refrigerant circuit, and the like) through the child controllers 20a, 20b and the like.

Further, the monitoring section 32a of the parent controller 30 may be configured to detect troubles based on the above information using the unique logics thereof. A detection result may be herein used for the search conditions C1, C2 and the like, and may be reflected in the visual aspects of the objects O1 to O6.

(13)

In the aforementioned exemplary embodiment, the objects O1 to O6 (especially, the objects O1 to O3 included in the tree structure T) is configured to be automatically created based on the data structure of the hierarchically-structured floor plan database 35a. However, the objects O1 to O6 may be configured to be automatically created based not on the floor plan database 35a but on the equipment IDs of the indoor units 10a, 10b and the like stored in the fundamental information database 35b.

For example, when a given indoor unit 10a, 10b and the like has an equipment ID “Facility 1 Building 1a 4F North Block 0A”, the equipment ID may be automatically divided into the following segments by a predetermined rule: “Facility 1”-“Building 1a”-“4F North Block”-“0A”. Further, the following objects may be automatically created: the object O1 corresponding to the segment “Facility 1”; the objects O2 and O4 corresponding to the segment “Building 1a”; the objects O3 and O5 corresponding to “4F North Block”; and the object O6 corresponding to “0A”.

In the present modification, it is possible to easily create the tree structure T only by naming the ID of a given indoor unit 10a, 10b or the like based on a predetermined rule. This is especially useful when there exist a large number of the indoor units 10a, 10b and the like and the tree structure T is accordingly formed in a large size.

(14)

In the aforementioned exemplary embodiment, the tree structure T is hierarchically structured for corresponding to the actual physical space structure of the facility 1. However, the tree structure T may be hierarchically structured for corresponding to a logical space structure. For example, a plurality of objects, respectively corresponding to corridors of the plural buildings 1a, 1b and the like, may be disposed immediately below the object “corridor”. Further, a plurality of objects, respectively corresponding to class rooms, may be disposed immediately below the object “class room”. Simply put, a superordinate space can be produced by integrating actually physically separated spaces.

When corresponding to a logical space structure, the tree structure T can be obviously automatically created similarly to the modification (13).

(15)

In the aforementioned exemplary embodiment, the floor plan database 35a is a hierarchically structured database. However, the floor plan database 35a is not limited to the above. For example, the floor plan database 35a may include two different databases. In this case, one is configured to store only floor plans, whereas the other is configured to store the hierarchical structure of the floor plans, i.e., information for managing the space structure of the facility 1.

(16)

An element for moving to the display configuration screen may not necessarily have the same configuration as the button B6 in the aforementioned exemplary embodiment. For example, a button of the same type as the button B6 may be disposed on the bottom of the frame A1 arranged on the left side of the screen. Further, the display configuration screen may be configured to be switched from another screen, which has opened in conjunction with press of the “CONFIGURATION” button B3 disposed in the frame A3 arranged on the right side of the screen.

Further, the configuration of the display configuration screen is not limited to that of the aforementioned exemplary embodiment. For example, the display configuration screen may be configured to allow the supervisory administrator to put a check mark for a condition formula that he/she wants to activate while a list of the search conditions C1, C2 and the like is displayed in order to make him/her specify the priority order of the search conditions C1, C2 and the like. Alternatively, the display configuration screen may be configured to allow the supervisory administrator to input numbers of the priority order.

### REFERENCE SIGNS LIST

1 Facility
1a, 1b Building
10 Air-conditioning installation
10a, 10b and the like Indoor unit (equipment)
20 Child controller
30 Parent controller (equipment management apparatus)
32 Control unit
32c Condition determination section
32d First display control section
32e Second display control section
34 Input unit (Configuration input unit)
O1 to O6 Objects
C1, C2 and the like Search conditions (Predetermined condition)
T Tree structure

### CITATION LIST

### Patent Literature

PTL 1: Japan Laid-open Patent Application Publication No. JP-A-2005-308278

1. An equipment management apparatus configured to provide a management screen in order to manage a plurality of equipments scattered within a superordinate space including a plurality of subordinate spaces, the equipment management apparatus comprising:
a first display control section configured to display a superordinate object and a plurality of subordinate objects in a tree structure on the management screen, the superordinate object corresponding to the superordinate space, and the subordinate objects corresponding to the subordinate spaces; and
a condition determination section configured to determine whether or not the equipments satisfy a predetermined condition,
the first display control section being further configured to change a visual aspect of at least one of the subordinate objects depending on a result of the determination by the condition determination section regarding whether or not one or more equipments disposed in the subordinate space corresponding to the subordinate object satisfy the predetermined condition.

2. The equipment management apparatus according to claim 1, further comprising:
a second display control section configured to display on the management screen the tree structure and a schematic view of the superordinate space or the subordinate space corresponding to one of the superordinate object and the subordinate object currently selected in the tree structure.

3. The equipment management apparatus according to claim 2, wherein
the schematic view includes a floor plan of the superordinate space or the subordinate space and one or more equipment objects corresponding to the one or more equipments.

4. The equipment management apparatus according to claim 3, wherein
the equipment objects are configured to function as links to detailed information about the equipments corresponding to the equipment objects.

5. (canceled)

6. The equipment management apparatus according to claim 1, wherein
the first display control section is further configured to change a visual aspect of the superordinate object depending on a result of the determination by the condition determination section regarding whether or not the equipments disposed in the superordinate space corresponding to the superordinate object satisfy the predetermined condition.

7. (canceled)

8. The equipment management apparatus according to claim 1, wherein
the predetermined condition includes an exclusion condition and an extraction condition, and
the condition determination section is further configured to determine that a particular one of the equipments satisfies the predetermined condition when the particular one of the equipments satisfies the extraction condition but dissatisfies the exclusion condition.

9. The equipment management apparatus according to claim 8, further comprising:
a configuration input unit configured to receive a configuration input of the exclusion condition.

10. The equipment management apparatus according to claim 1, further comprising:
a logic storage unit configured to store a control logic; and
a logic execution section configured to execute the control logic, the control logic being configured to be triggered by signals outputted by the condition determination section depending on a result of the determination regarding whether or not the equipments satisfy the predetermined condition.

11. The equipment management apparatus according to claim 1, further comprising:
a name storage section configured to store respective equipment names of the equipments,
the first display control section being further is configured to automatically create the tree structure with reference to the equipment names stored in the name storage section.

12. The equipment management apparatus according to claim 1, wherein
the predetermined condition includes a plurality of condition formulas and the having a priority order preliminarily defined, and
the first display control section is further configured to display the visual aspect of at least one of the subordinate objects in a predetermined display format when the condition determination section determines that one or more equipments disposed in the subordinate space corresponding to the subordinate object satisfy two or more of the condition formulas, the predetermined display format corresponding to a highest-prioritized one of said two or more of the condition formulas.

13. The equipment management apparatus according to claim 6, wherein
the predetermined condition includes a plurality of condition formulas having a priority order preliminarily defined, and
the first display control section is further configured to display the visual aspect of the superordinate object in a predetermined display format when the condition determination section determines that the equipments disposed in the superordinate space corresponding to the superordinate object satisfies two or more of the condition formulas, the predetermined display format corresponding to a highest-prioritized one of said two or more of the condition formulas.

14. The equipment management apparatus according to claim 12, further comprising;
a configuration input unit configured to receive a configuration input of the priority order.

15. The equipment management apparatus according to claim 1, further comprising:
a request source specifying unit configured to specify a request source requesting the management screen; and
a condition formula storage unit configured to store the predetermined condition in association with the request source,
the first display control section being further is configured to change the visual aspect of at least one of the subordinate objects on the management screen to be provided to the request source specified by the request source specifying unit depending on a result of the determination by the condition determination section regarding whether or not one or more equipments disposed in the subordinate space corresponding to the subordinate object satisfy the predetermined condition associated with the request source.
